(19) United States
(12) Patent Application Publication
(10) Pub. No.: US 2013/0330445 A1
(43) Pub. Date: Dec. 12, 2013

(54) METHOD OF STORING PRODUCE AND PRODUCING A BEVERAGE

(71) Applicant: Adrian Spiers, Palmerston North (NZ)

(72) Inventor: Adrian Spiers, Palmerston North (NZ)

(21) Appl. No.: 13/820,324

(22) PCT Filed: Sep. 1, 2011
(86) PCT No.: PCT/NZ2011/000175

§ 371 Date: May 9, 2013

(30) Foreign Application Priority Data
Sep. 1, 2010 (NZ) 587731
Jan. 17, 2011 (NZ) 590547

(51) Int. Cl. A23B 7/158

(52) U.S. Cl. CPC A23B 7/158
USPC 426/106

(57) ABSTRACT

A method of storing harvesting produce in a storage solution and a packaged beverage produced utilizing the method are disclosed. The harvest produce may be whole fruit or diced root vegetables. The storage solution is characterized in that a neutral water potential is established when the harvested produce is immersed in the solution. The packaged beverage is characterised in that the container provides both first and second releasable seals that permit the solution to be drunk and the harvested produce to be eaten.

### FIELD OF INVENTION

The invention relates to a method of maintaining and/or enhancing the desirable characteristics of harvested produce and a packaged beverage that utilises the method. In particular, the invention relates to a packaged beverage comprising harvested produce in a drinkable storage solution.

### BACKGROUND

Customers prefer to purchase and consume produce that is perceived to be fresh. Many desirable characteristics are associated with fresh produce including nutritional value, flavour and texture. These desirable characteristics are frequently lost when fresh produce is stored for anything more than a minimal period of time. The nutritional value and flavours of fresh produce are associated with labile components that are lost by way of metabolism or degradation by abiotic factors such as oxygen and heat. Likewise, the texture of fresh produce may deteriorate if over ripening or dehydration occurs. The loss of these desirable characteristics is particularly pronounced in stored produce such as fruit. Fruit may rapidly become unpalatable unless steps are taken to inhibit or at least limit metabolism and degradation. These steps may include storage in controlled temperature and controlled atmosphere environments.

Storage in controlled temperature and controlled atmosphere environments, whilst reducing the deterioration in fruit quality attributable to metabolism to a certain extent, does not exclude a degree of dehydration of the fruit. Dehydrated fruit lacks its turgid or crisp texture and is unappealing to the consumer. Nor is the degree of dehydration sufficient to prevent degradation by biotic factors, such as postharvest storage rots. Indeed, the degree of dehydration may promote storage rots. Many other methods have been explored for the storage and preservation of produce, in particular fruit. These methods invariably result in the loss of desirable characteristics of the fruit. The methods include the immersion of the fruit or the application to the fruit of hypertonic solutions to partially dehydrate the fruit. The dehydrated fruit may then be infused with humectants to improve the texture of the fruit in such a way as to mimic the texture of fully hydrated fresh fruit, or at least provide a mouth feel and texture that is acceptable to consumers.

Tressler and Evers (1957) in ‘The Freezing Preservation Of Foods’ (Westport: Avi Publishing) describe a method of treating peaches prior to storage with a mixture of ascorbic acid and sugar in order to draw out some of the juice and obtain some penetration of the ascorbic acid and the sugar. The peach slices are mixed with one quarter of their weight of sugar containing 0.6% of ascorbic acid and allowed to stand for 2 to 3 hours. The peaches thus prepared are used in the preparation of a filling for a pie. Nicotra et al (1973) in ‘Considerations Of The Suitability For Freezing Of Some Peach And Apricot Varieties’ (Proceedings of the 13^{th} International Congress of Refrigeration, “Progress in Refrigeration Science and Technology” International Institute of Refrigeration) describes studies with different times of dipping of fruit pieces in different types of syrup with and without calcium salts. Three calcium salts were tested by adding them to the syrup to prevent or reduce the loss of firmness of the flesh. The methods of Tressler and Evers (1957) and Nicotra et al (1973) are both directed towards preserving fruit where the fruit is dehydrated and then frozen.

The specification accompanying United Kingdom patent application no. 1375704 (Johnson (1974)) describes a process for preserving fruit. The process comprises effecting the absorption of a humectant chosen from glycerol, propylene glycol, sorbitol, or any other polyhydric alcohol capable of acting as a humectant into the food and thereafter affecting partial removal of water from the fruit to obtain a partially dehydrated product. The level of dehydration is such that the water activity of the food is below that at which bacterial and enzymatic activity take place. The partially dehydrated produce is then stored, for example, as a freeze-dried product. The specifications accompanying U.S. Pat. Nos. 4,256,772 (Shanbhag et al), 4,364,968 (Waitman and Frank), 4,542,033 (Agarwala) and 5,364,643 (Morimoto and Lugay) also describe methods of improving the storage characteristics of produce, including fruit. The produce is immersed in a solution containing an aqueous solution of an edible polyhydric alcohol and/or carbohydrate at a concentration sufficient to dehydrate the produce and allow infusion with the edible humectant. In each of the methods described in these patent specifications the fruit is exposed to a coating or solution that is hypertonic, thereby dehydrating and preserving the produce. Infusion with the humectant is directed to improving the texture of the preserved produce. Similarly, the specification accompanying international application no. PCT/US1999/000181 (publ. no. WO 99/35917) (Hirschberg (1999)) describes methods of infusing phytochemicals, nutraceuticals, and other compositions into food products. The claimed method of infusing a composition into a food product includes the step of increasing the Brix of a dehydration solution containing the food product over a period of time. The method seeks to maintain or enhance the quality of the stored produce by partially dehydrating the produce and infusing the produce with substances that substitute for and mimic the natural characteristics of the fresh produce. These known methods are in accordance with the paradigm that the water activity of the stored food must be reduced to a certain level to prevent deterioration by biotic factors. The water activity is reduced by dehydration. Dehydration is achieved by application to the produce or immersion of the produce in a hypertonic solution.

The specification accompanying U.S. Pat. No. 4,879,127 (Liu et al (1989)) describes a process for storing diced or sliced produce for extended periods of time prior to further processing. The produce is immersed in a substantially isotonic aqueous storage solution. The produce is then stored at a reduced temperature prior to canning and sterilisation. The specification accompanying U.S. Pat. No. 4,996,070 (Nafisi-Movaghar (1991)) describes a process for preparing natural fruit flavour extracts. The extract is produced by preparing an infusion solution and immersing a fruit in the solution for a period of time to infuse the fruit with the solution. After infusion, the solution contains significant portions of the fruit sugars, colours, flavours and pectins from the fruit. The process described is directed to the extraction of fruit flavours without preservation of the fruit. Furthermore, none of the examples provided describe the extraction of fruit flavours from whole fruit. These known methods do not seek to maintain or enhance the natural characteristics of the stored produce. The known methods are not applicable to the storage of whole produce, in particular whole fruit. Generally, the known methods are directed to the storage and preservation of produce with a view to its subsequent use in processed food products. By contrast, the specification accompanying U.S. patent application Ser. No. 11/454,814 (publ. no. US 2006/0233922) (Kegler et al (2006)) describes a method of enhancing the flavour of fruits or vegetables within its own product packaging to extend the shelf life and allow for mass production and mass distribution of the flavour enhanced fruits or vegetables, and the packaged flavour enhanced fruits or vegetable products produced by such methods. The methods comprise introducing carbon dioxide (CO₂) as a means of enhancing fruit characteristics, but uses known means, i.e. freezing, to achieve preservation of the flavour enhanced fruit during storage.

An object of this invention is to provide a packaged beverage comprising harvested produce in a drinkable storage solution. An object of this invention is to provide a method of maintaining and/or enhancing the natural characteristics of produce. These objects are to be read disjunctively with the object to at least provide the public with a useful choice.

### STATEMENTS OF INVENTION

In a first aspect the invention provides a packaged beverage consisting of a releasably sealed container containing harvested produce immersed in an aqueous storage solution where the container comprises a first releasable seal and a second releasable seal configured to permit the egress of the storage solution without the harvested produce when the first releasable seal is released and egress of the harvested produce when the second releasable seal is released.

Preferably, a neutral water potential is established when the harvested produce is immersed in the aqueous storage solution.

Preferably, the storage solution is a moderately hypotonic to substantially isotonic storage solution.

Preferably, there is no significant change in the Brix value of the storage solution of the packaged beverage during the period of storage.

Preferably, the storage solution is a carbonated storage solution.

Preferably, the storage solution is an alcoholic storage solution. More preferably, the storage solution is an alcoholic storage solution where the source of alcohol is selected from the group consisting of: pomace brandy, triple sec liqueur, gin, vodka and whisk(e)y (or bourbon).

Preferably, the storage solution comprises a combination of solutes selected from the group consisting of: artificial sweeteners and polyhydric alcohols (polyols). More preferably, the storage solution comprises a combination of artificial sweeteners and polyhydric alcohols (polyols) where the artificial sweeteners are selected from the group consisting of: SUCARYL™ (Abbott) (sodium cyclamate 8% (w/v) (952), sodium saccharin 0.8% (w/v) (954), benzoic acid 0.1% (210)); EQUAL™ (Merisant) (5% Benzoic acid (210), potassium benzoate (212)) and SUGORMAX™ (Hansells) (16% sodium cyclamate, 4% saccharin, malic acid, preservatives (211, 202)) and the polyhydric alcohols (polyols) are selected from the group consisting of: glycerol, inositol, mannitol, and sorbitol.

In a first embodiment of the first aspect of the invention the harvested produce is whole fruit. More preferably, the harvested produce is whole fruit selected from the group consisting of: apple, blackberries, blueberries, cherries, citrus, grapes, kiwifruit, peaches, pear, plums, raspberries and strawberries.

In a second embodiment of the first aspect of the invention the harvested produce is diced root vegetables. More preferably, the harvested produce is diced root vegetables selected from the group consisting of: beetroot, carrot and ginger.

In a second aspect the invention provides a method of storing harvested produce comprising the step of immersing the harvested produce in an aqueous storage solution contained in a releasably sealed container to establish a neutral water potential.

Preferably, the storage solution is a moderately hypotonic to substantially isotonic storage solution.

Preferably, there is no significant change in the Brix value of the storage solution during the period of storage.

Preferably, the storage solution is a carbonated storage solution.

Preferably, the storage solution is an alcoholic storage solution. More preferably, the storage solution is an alcoholic storage solution where the source of alcohol is selected from the group consisting of: pomace brandy, triple sec liqueur, gin, vodka and whisk(e)y (or bourbon).

Preferably, the storage solution comprises a combination of solutes selected from the group consisting of: artificial sweeteners and polyhydric alcohols (polyols). More preferably, the storage solution comprises a combination of artificial sweeteners and polyhydric alcohols (polyols) where the artificial sweeteners are selected from the group consisting of: SUCARYL™ (Abbott) (sodium cyclamate 8% (w/v) (952), sodium saccharin 0.8% (w/v) (954), benzoic acid 0.1% (210)); EQUAL™ (Merisant) (5% Benzoic acid (210), potassium benzoate (212)) and SUGORMAX™ (Hansells) (16% sodium cyclamate, 4% saccharin, malic acid, preservatives (211, 202)) and the polyhydric alcohols (polyols) are selected from the group consisting of: glycerol, inositol, mannitol, and sorbitol.

Preferably, the container is a releasably sealed container. More preferably, the container is a releasably sealed container where the container comprises a first releasable seal and a second releasable seal configured to permit the egress of the storage solution without the harvested produce when the first releasable seal is released and egress of the harvested produce when the second releasable seal is released.

In a first embodiment of the second aspect of the invention the harvested produce is whole fruit. More preferably, the harvested produce is whole fruit selected from the group consisting of: apple, blackberries, blueberries, cherries, citrus, grapes, kiwifruit, peaches, pear, plums, raspberries and strawberries.

In a second embodiment of the second aspect of the invention the harvested produce is diced root vegetables. More preferably, the harvested produce is diced root vegetables selected from the group consisting of: beetroot, carrot and ginger.

In the description and claims of this specification the following acronyms, terms and phrases have the meaning provided: “Alcoholic storage solution” means an aqueous storage solution to which a portion of alcohol has been added; “Aqueous storage solution” means a storage solution prepared by the addition of solutes to water; “Comprising” means “including”, “containing” or “characterized by” and does not exclude any additional element, ingredient or step; “Consisting of” means excluding any element, ingredient or step not specified except for impurities and other incidentals; “Diced” means cut into pieces; “Dry weight” means the weight after drying to constant weight; “Harvested” means produce is gathered and placed in a container after the produce has grown to a harvestable form; “Molarity” means the concentration (M) in an aqueous solution of a solute; “M” denotes mole (mol) per litre (L); “Mole” means the amount of substance that contains as many entities (atom, molecules, ions, electrons, photons etc.) as there are atoms in 12 g of ¹²C; “Molecular species” means the charged or uncharged molecules formed when a solute is dissolved in an aqueous medium to provide an aqueous solution; “Neutral water potential” means the water potential of a storage solution at which there is no significant increase in the wet weight of the harvested produce (in this context “no significant increase” means no more than 5% for whole fruit (preferably no more than 2.5%) or no more than 10% for diced vegetables (preferably no more than 5%), or in the alternative the water potential of a storage solution at which there is minimal rupturing of cells (as indicated by no significant change in the Brix value of the storage solution); “Solute” means the molecule or salt dissolved in an aqueous medium; “Tonicity” means the sum of the concentrations (M) in an aqueous solution of molecular species to which a plant cell membrane is impermeable.

It will be understood from the foregoing definitions that a solute that is a molecule may form one or more molecular species when dissolved in an aqueous medium. It will be recognised that the concentrations (M) of molecular species in an aqueous solution are influenced by the degree of dissociation (if any) of the solute when dissolved in the aqueous medium. It will also be recognised that in the solutions used in the present invention molecular species may be sequestered by mechanisms such as adsorption and chelation. The degree of adsorption, chelation, dissociation and volume of the aqueous solution is also influenced by variables such as temperature. For these reasons the phrases “neutral water potential”, “moderately hypotonic” and “substantially isotonic” are to be understood in a functional sense. A “neutral water potential” is readily determinable for a given combination of diced or whole harvested produce and concentrations of solutes in a storage solution on the basis of no significant change in the wet weight of the harvested produce or no increase in the Brix value of the storage solution. “Hypotonic” and “isotonic” mean with respect to the tonicity of the cells of the harvested produce to be stored prior to immersion in the storage solution. Accordingly, the phrase “moderately hypotonic to substantially isotonic” encompasses a range with respect to the tonicity of the harvested produce to be stored sufficient to maintain the hydration of the produce and establish the neutral water potential without the outer skin or peel of the produce or membranes of the cells rupturing. The required concentration of solutes can be readily determined employing the methods illustrated in the Examples.

Where concentrations or ratios are specified in respect of the preparation of a storage solution the concentration or ratio, specified is the initial concentration or ratio in the storage solution. Where values are expressed to one or more decimal places standard rounding applies. For example, 1.7 encompasses the range 1.650 recurring to 7.499 recurring. The terms “first”, “second”, “third”, etc. when used with reference to alternative embodiments of the invention, or with reference to different elements, features or integers of the subject matter defined in the Statements of Invention and Claims, are not intended to imply an order of preference.

### BRIEF DESCRIPTION OF DRAWINGS

FIG. 1. Representation of a first embodiment consisting of a can-shaped releasably sealed container (1) containing harvested produce (7) immersed in a storage solution (8) as described in the specification.

FIG. 2. A sequence of representations in accordance with the first embodiment illustrating the release of the first releasable seal (5) by pulling the ring (10) and the release of the second releasable seal (6) by pulling the ring (12).

FIG. 3. A sequence of representations in accordance with the first embodiment illustrating the egress of the stored produce from the container (1) following release of the second releasable seal (6) to provide an opening (13). The harvested produce (7) is collected on a plate (14).

FIG. 4. A photograph of a mock-up of a lid (4) of a container in accordance with the first embodiment comprising a first releasable seal and a second releasable seal showing a possible configuration of the associated ring pulls.

FIG. 5. Photographs illustrating an apple (FIG. 5a), a clear walled container containing a carbonated storage solution (FIG. 5b) and a container containing the apple immersed in the carbonated storage solution (FIG. 5c) in accordance with the first embodiment.

FIG. 6. Photographs illustrating a kiwifruit (FIG. 6a), a clear walled container containing a carbonated storage solution (FIG. 6b) and a container containing the kiwifruit immersed in the carbonated storage solution (FIG. 6c) in accordance with the first embodiment.

FIG. 7. Photographs illustrating a lemon (FIG. 7a), a clear walled container containing a carbonated storage solution (FIG. 7b) and a container containing the lemon immersed in the carbonated storage solution (FIG. 7c) in accordance with the first embodiment.

FIG. 8. Photographs illustrating a lime (FIG. 8a), a clear walled container containing a carbonated storage solution (FIG. 8b) and a container containing the lime immersed in the carbonated storage solution (FIG. 8c) in accordance with the first embodiment.

FIG. 9. Representation of a second embodiment consisting of a bottle shaped releasably sealed container (1) containing harvested produce (7) immersed in a storage solution (8) as described in the specification.

FIG. 10. A sequence of representations in accordance with the second embodiment illustrating the release of the first releasable seal by unscrewing the top cap (18) and the release of the second releasable seal by unscrewing the base cap (17).

FIG. 11. Representations in accordance with the second embodiment illustrating the egress of the harvested produce from the container (1) following release of the second releasable seal to provide an opening (13). The harvested produce (7) is collected on the base cap (17).

FIG. 12. Representations of two alternatives of a third embodiment consisting of a pouch-shaped container (1) containing harvested produce (7) immersed in a storage solution (8) as described in the specification.

FIG. 13. A sequence of representations in accordance with the third embodiment illustrating the release of the first releasable seal by unscrewing the cap (5).

FIG. 14. Representations in accordance with the third embodiment illustrating release of the second releasable seal by tearing open the pouch-shaped container to provide an opening.

### DETAILED DESCRIPTION

The inventor has adopted a new paradigm when considering the storage of harvested produce. Rather than seeking to reduce the water activity of stored produce to a level that inhibits enzyme and bacterial activity with a view to preservation, the method described here seeks to maintain the vitality of fresh produce or to revitalise stored produce by maintaining or returning the water activity of the produce at or to that of fresh produce. Surprisingly, the inventor has discovered that under these conditions the produce can be preserved in a releasably sealed container for significant periods of time. Additional advantages accrue, such as the provision of a drinkable storage solution. The method allows for what the inventor characterises as the “reverse ripening” of harvested produce. Whilst one objective is to maintain the natural characteristics of stored produce, it will also be recognised by those skilled in the art, and as demonstrated here, that in addition the natural characteristics of stored produce can also be enhanced or new qualities introduced. Stored fruit revitalised according to the method may be preserved for periods of 30 to 45 days, or 60 to 90 days at reduced temperatures of 2 to 5° C., depending upon the fruit type.

Provided the tonicity of the storage solution is moderately hypotonic or substantially isotonic with respect to the tonicity of the fruit to be stored prior to immersion in the solution, a neutral water potential between the interna of the whole fruit and the solution will be established. The outer membranes of cells are semi-permeable. These cell membranes allow the passage of water and certain solutes. Plant cells are also surrounded by a semi-rigid cell wall. The characteristics of this cell wall may also affect the passage of water and solutes. The passage of water across the outer membrane of a plant cell is determined by potentials including: Osmotic potential (controllable by solute concentration); Turgor potential (determined by the hydrostatic pressure of the contents of a cell); and Matric potential (dependent in part on the nature of the cell wall). The summation of these potentials is the “water potential” between the inside and outside of the cell. The turgor potential is related to the condition of the harvested produce. Freshly harvested produce typically has a relatively high turgor potential. Stored fruit, which has become at least partially dehydrated, has a lower turgor potential or may even be flaccid. Matric potential is related to the characteristics of the cell membrane and cell wall which is in turn related to the type of produce. The contribution matric potential makes to the water potential will vary between different types of fruit. The matric potential will differ, for example, between grapes and apples. For whole fruit, the characteristics of the outer skin of the fruit will also have an influence on the water potential. Where whole fruit with a permeable outer skin is immersed in a hypotonic solution there will be a net update of water due to the osmotic potential between the inside of the cells and the immersion solution. With the uptake of water the turgor potential will increase; an increase in the volume of the cells is limited by the semi-rigid cell wall. An increase in the volume of the whole fruit is limited by the outer skin or peel of the fruit; the outer skin or peel of the fruit will rupture if the solution is too hypotonic. If the turgour potential is insufficient to counter the uptake of water attributable to the osmotic potential, a “neutral water potential” will not be established. “Neutral water potential” is defined as being a balance between the osmotic, turgor and matric potentials that is established and results in a zero net passage of water between the interna of the whole fruit and the solution as manifested in there being no significant change in the portion of the wet weight of the harvested produce attributable to the weight of water before and after immersion of the harvested produce in the storage solution or in the Brix value of the storage solution remaining constant. Significant changes in the Brix value of the storage solution are indicative of cell membranes being ruptured.

Whilst not wishing to be bound by theory it is believed the desirable characteristics of the harvested produce are maintained and/or regained under conditions of “neutral water potential” because the stored produce is being kept alive and vital, albeit in stasis. That is, the ripening processes are being prevented from proceeding beyond a certain point and may even be reversed under certain circumstances. It will be recognised that the required initial concentration of the solutes in the immersion solution will depend both on the initial condition of the fruit and the fruit type. Whole fruit with an intact outer skin should be used. The advantages of the invention will most readily be recognised when whole fresh fruit is used. In addition to the desirable outcomes already described, new characteristics can be imparted on the stored produce. For example, the storage solutions may be flavoured; the outer skin of the fruit may be tenderised; or the fruit may be carbonated to provide a novel taste sensation and preferred mouth-feel when consumed.

The invention will now be described by way of example only. It will be recognised by those skilled in the art that once the advantages of immersing whole fruit in storage solutions with a view to establishing a neutral water potential (as defined and described herein) are recognised the preparation of moderately hypotonic to substantially isotonic solutions for the storage of a range of whole fruit can readily be determined for different fruit types. Furthermore, the extension of similar principles to the storage of diced harvested produce is contemplated. In this latter case the contribution of the peel or skin to establishing the neutral water potential is discounted.

Fresh harvested fruit are preferably surface sterilised prior to immersion in the storage solution using a sodium hypochlorite solution or any of a number of commercially available sanitizers. Depending on the storage and shelf life requirements of the packaged beverage the storage solution may optionally contain a compatible preservative as an alternative or supplement to filter sterilisation. Such preservatives may include dimethyl dicarbonate (VELCORIN™), potassium sorbate, sorbic acid (E200), potassium sorbate (E202), benzoic acid (E210), sodium benzoate (E211), ethyl 4-hydroxy benzoate (E214), ethyl parahydroxybenzoate, sodium sulphite (E221), sodium metabisulphite (E223), malic acid (E296), carbon dioxide (E290), lactic acid (E270). In addition, the artificial sweetener SUCARYL™ contains 0.1% of the preservative benzoic acid. An absence of microbial growth has been observed in the packaged beverages when a storage solution containing polyols and artificial sweeteners is prepared with unsterilized water and the whole fruit has not been surface sterilised. Artificial sweeteners may be used in the storage solution and are particularly favoured for use as ingredients in conjunction with polyols. Sorbitol is useful in solutions with artificial sweeteners to remove the bitter after taste sometimes associated with these products (Merck Index 12^{th} Ed). In addition to SUCARYL™ (Abbott) (sodium cyclamate 8% (w/v) (952), sodium saccharin 0.8% (w/v) (954), benzoic acid 0.1% (210)) artificial sweetners include EQUAL™ (Merisant) (5% Benzoic acid (210), Potassium benzoate (212)) and SUGORMAX™ (Hansells) (16% sodium cyclamate, 4% saccharin, malic acid, preservatives (211, 202)).

When preparing a packaged beverage, whole fruit is placed in a container which is slightly larger than the fruit. For example, a 160 gm apple placed in such a container would require approx 170 ml of storage solution to cover the fruit completely. As noted already, the composition of the solution is determined both by the fruit type and desired outcome. These determinations can be made as outlined in the examples. The container is then sealed. Fruit placed in the solution may be stored at ambient temperatures around 20° C. The shelf life is increased by storing below 20° C. preferably below 10° C. The fruit is preferably stored above 0° C. to prevent freezing. An extended shelf-life may be pursued by the inclusion of preservatives in the storage solution, but is not essential to all embodiments. For carbonated fruit the solution is charged with carbon dioxide prior to immersing the fruit in the storage solution. A releasably sealed gas tight container is required to keep the gas in solution. The outer skin or peel of the stored fruit will often rupture once the container is opened due to the release of gaseous pressure. This is to be distinguished from the rupturing of the peel or skin that may occur if a neutral water potential is not established. The fruit is typically ready to eat with enhanced characteristics within five days of packing and will store for up to three months depending upon storage temperature, fruit type and composition of the storage solution.

It will be noted that the method and packaged beverage of the invention is distinguished from the traditional French method of preparing eau de vie de poire in that the method of the invention uses produce that has been harvested before being placed in a container to be releasably sealed. In the traditional French method the whole fruit (pear) is grown in the container (bottle) before it is harvested. The method and packaged beverage of the invention is also distinguished from known beverages, e.g. fruit juices and fruit floats, purporting to contain “fruit pieces” in that these fruit pieces are neither whole fruit nor diced fruit. In these known beverages the “fruit pieces” are portions of the flesh of the fruit arising from crushing or maceration of the whole fruit, as opposed to dicing. It will be recognised that when the flesh of whole produce is diced it retains a structural integrity and texture of the flesh of the whole produce absent from what is more accurately described as “fruit pulp”. The whole produce that may be diced and used in accordance with the method of the invention includes the tubers, stems, roots etc. of vegetables. When diced, this produce will retain its structure in solution, even when the solution is carbonated. Examples of suitable produce include ginger, turmeric, ginseng, carrot and, parsnip. Greater latitude in the tonicity of the storage solution is permitted when diced vegetables are immersed.

If an alcoholic storage solution is used grappa (triple sec liqueur) made from fermented grape skins, is a favoured addition to the solution. Grappa has been observed to have a particularly good ability to elicit flavours from fruit. Grappa has been used with apples, pears, kiwifruit. Other favoured combinations include grapes with gin, Cointreau (pomace brandy), brandy or vodka; orange with vodka or Cointreau (pomace brandy); lemons with gin; limes with gin or vodka; kiwifruit with whisk(e)y; and pears with brandy, vodka or grappa. These sources of alcohol are typically used at concentrations of 5 to 7.5% (v/v) depending upon the fruit and total composition of the final storage solution. Caffeine may also be added to a storage solution if desired. When selecting the precise composition of the storage solution it will be recognised that the palatability of the resulting beverage will be a matter of subjective opinion. It is therefore inconsistent with the intent of the description provided in this specification to limit the user to any particular combination of ingredients for use in preparation of the storage solution. The advantages accrue from the establishing a neutral water potential as discussed above and the use of a releasable sealed container that provides the consumer with a convenient and desirable packaged beverage. Several alternative embodiments of the packaged beverage will now be described for the purpose of illustrating, but not limiting the scope of the application of the invention. The use of packaging formats similar in shape and dimension to existing packaging formats facilitates the incorporation of the packaged beverages into existing product lines.

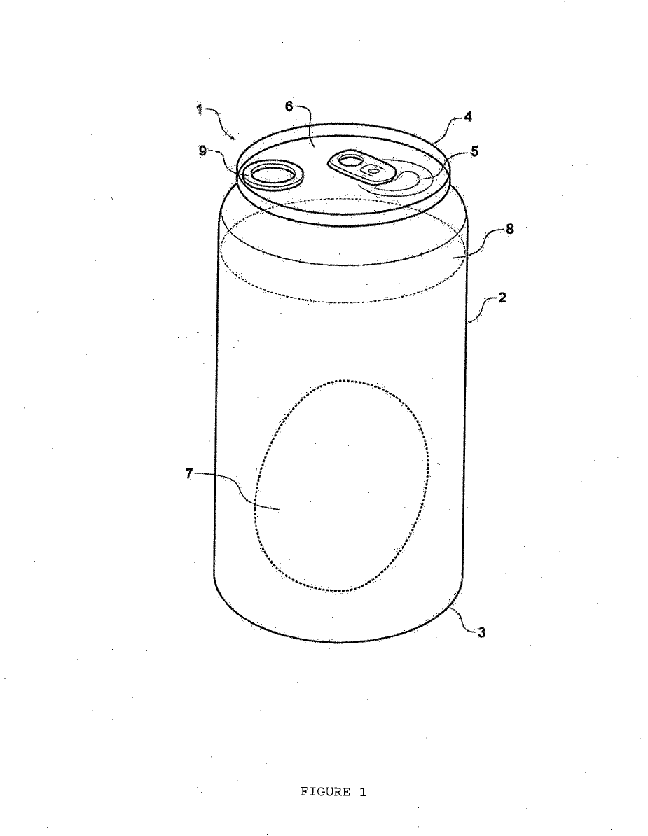

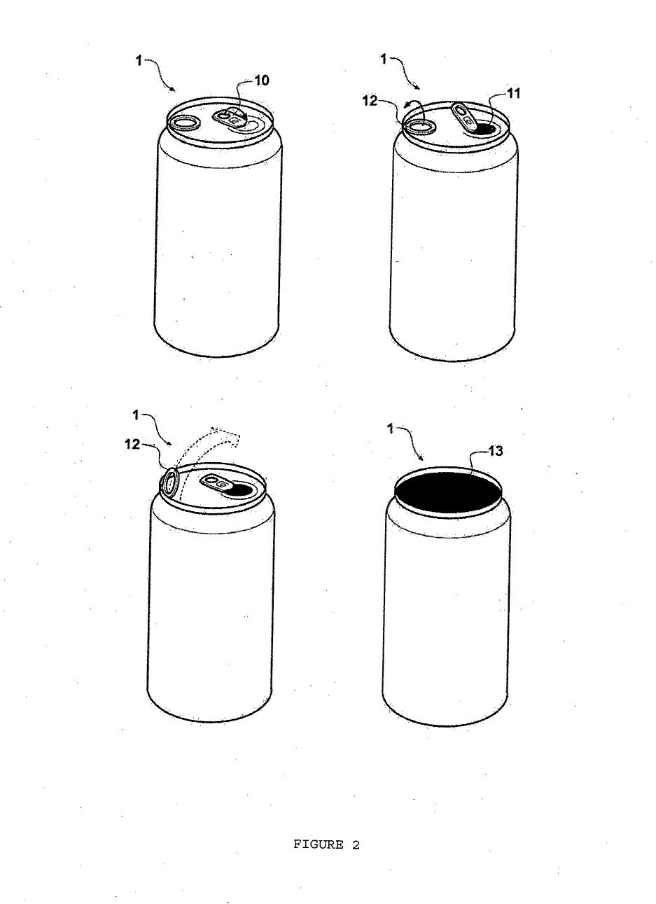

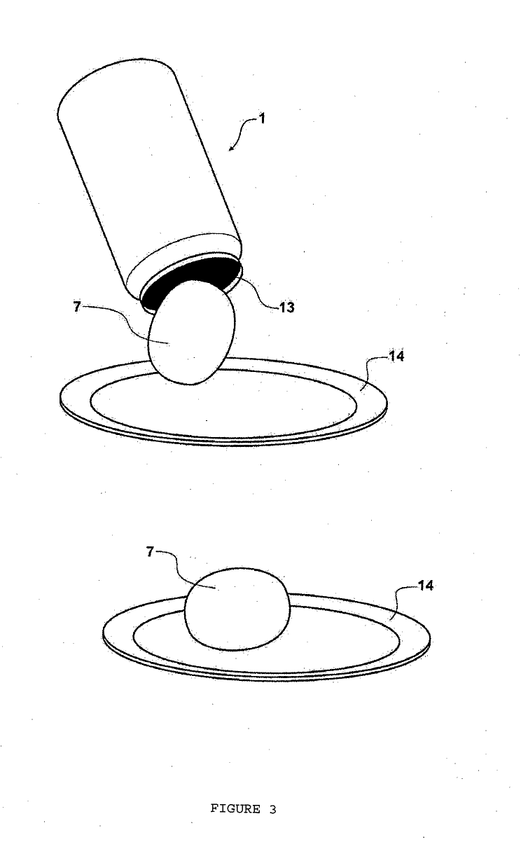

A first embodiment of the packaged beverage is illustrated in FIG. 1 of the drawings pages. The figure presents a releasably sealed container (1) similar if not identical in dimension and shape to a conventional drinks can. The container is formed from unitary sidewalls (2) and base (3) sealed with a lid (4). The container (1) is provided with a first releasable seal (5) and a second releasable seal (6) comprised in the lid. In the embodiment illustrated in the Figure the first releasable seal (5) is of the type encountered in a conventional drinks can. Referred to as a releasable seal of the “pop top” type it will be recognised that the releasable seal could be replaced by a releasable seal of the ring pull type or even a screw top or stopper. Convenience and facility of manufacture and container type will influence the selection of the type of first releasable seal. The first releasable seal is a means for providing an opening in the lid of the container that is sufficiently large to permit the egress of the stored solution so that it may be drunk, but not so large, as to permit the egress of the harvested produce (7) contained in the container and initially immersed in the storage solution. The second releasable seal (6) is of the type commonly encountered on cans of meats or vegetables. The second releasable seal (6) comprises a ring (9) that when pulled causes the lid of the container (or at least a substantial portion of the lid of the container) to separate from the side walls (2) of the container to provide a second opening. The second releasable seal is a means for providing an opening that is sufficiently large to allow egress of the produce (7) from the container (1). It will be recognised that types of container with this configuration of seals other than those illustrated may be used in accordance with the methods of the invention. These other types of container might include those of the plastic pouch or cardboard type. It will also be recognised that to satisfy the means for providing an opening that is sufficiently large to allow egress of the produce from the container alternatives to the ring and pull mechanism described and illustrated may be employed. One such mechanism could be for the lid to be a screw top of the container. A configuration including a screw top as the second releasable seal would be particularly suited to situations where the container was to be reusable. Although the illustration presents a configuration of first releasable seal and second releasable seal where the first releasable seal is comprised in the second releasable seal it is contemplated that this need not be the case. However, it will be recognised that the illustrated configuration is particularly appealing to consumers familiar with conventional “pop top” and can opening means. The sealed container (1) contains a volume of storage solution (8) that is sufficient to ensure the produce (7) is near constantly immersed in the storage solution (8). As the stored solution (8) is only moderately hypotonic to substantially isotonic its density will generally be of a value less than that of the immersed produce. The produce will therefore tend to remain immersed in the stored solution. When a consumer wishes to drink the storage solution it is a simple action to release the first releasable seal (5) by pulling the ring (10) to provide an opening (11) through which the storage solution (8) may be poured (FIG. 2-upper left to right). When a consumer wishes to consume the produce it is a simple action to release the second releasable seal (6) by pulling the ring (12) and remove the lid of the container (4) or a substantial portion thereof to provide an opening through which the produce may be removed (FIG. 2-lower left to right, FIG. 3-upper to lower).

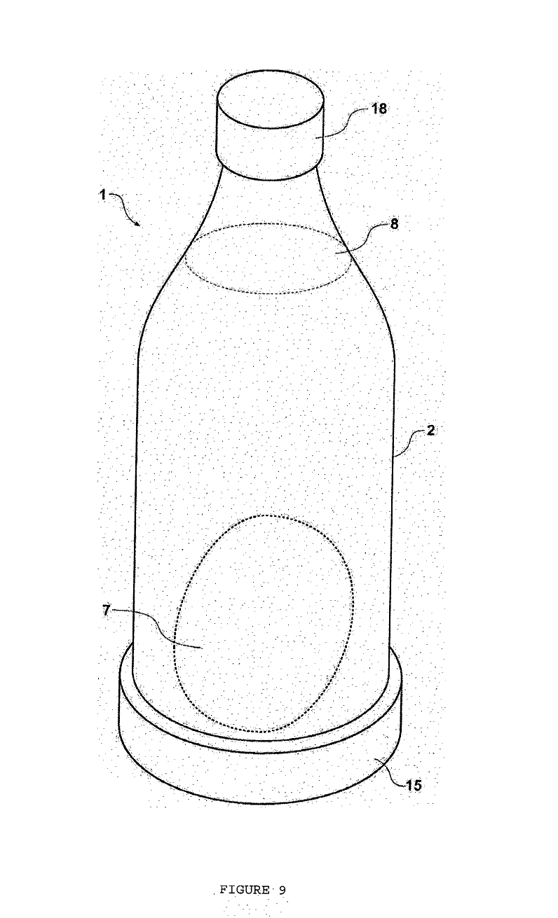

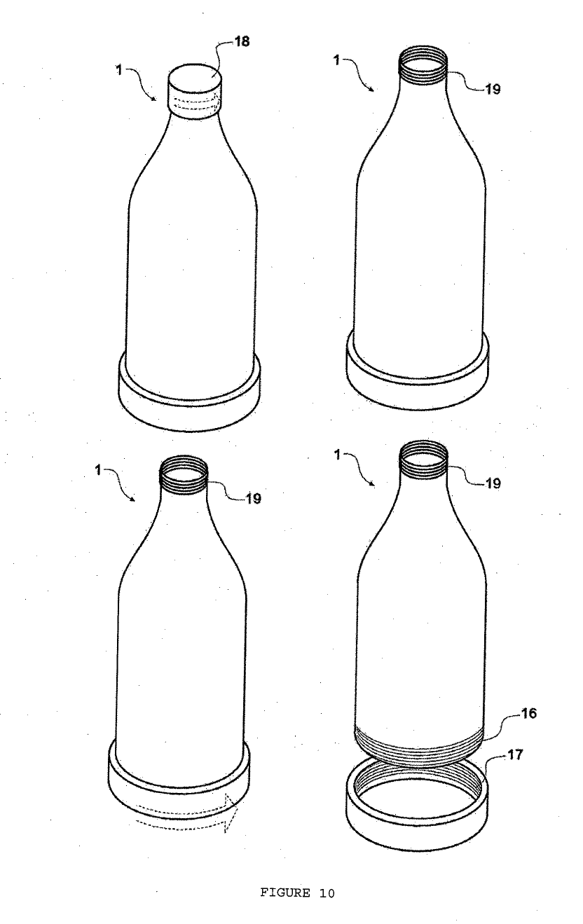

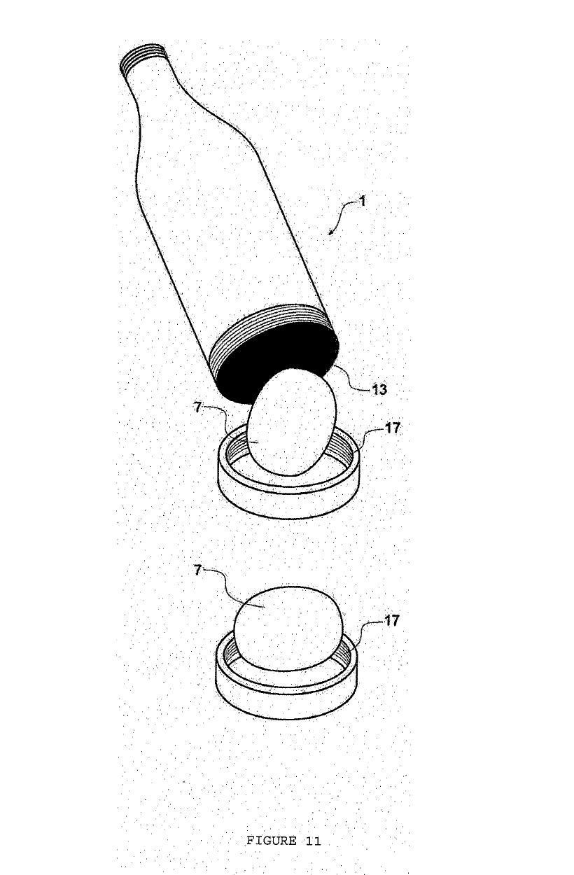

A second embodiment of the invention is similarly illustrated in FIGS. 9 to 11 of the drawings pages. The Figures present a releasably sealed container (1) of similar dimensions and shape to a conventional drinks bottle. The container is formed from side walls that taper to provide a smaller opening at the top and a larger opening at the base. The container is releasably sealed with a base cap (17) and top cap (18). The base cap (17) may engage with and seal the base open end by means of a screw thread (16). The top cap (18) may engage with and seal the top open end by means of a screw thread (19). In this embodiment the first releasable seal is provided by the cap (18) that may be disengaged from the container by unscrewing. The opening provided by the unscrewing of this first releasable seal is sufficiently large to permit the egress of the storage solution so that it may be drunk by the consumer, but not so large, as to permit the egress of produce (7) contained in the container and initially immersed in the storage solution. Similarly, unscrewing of the base cap (17) that is the second releasable seal provides a second opening that is sufficiently large to allow egress of the produce (7) from the container (1). In this second embodiment of the invention the base cap (17) may serve as a receptacle for the produce (7) once removed from the container as illustrated in FIG. 11 of the drawings pages.

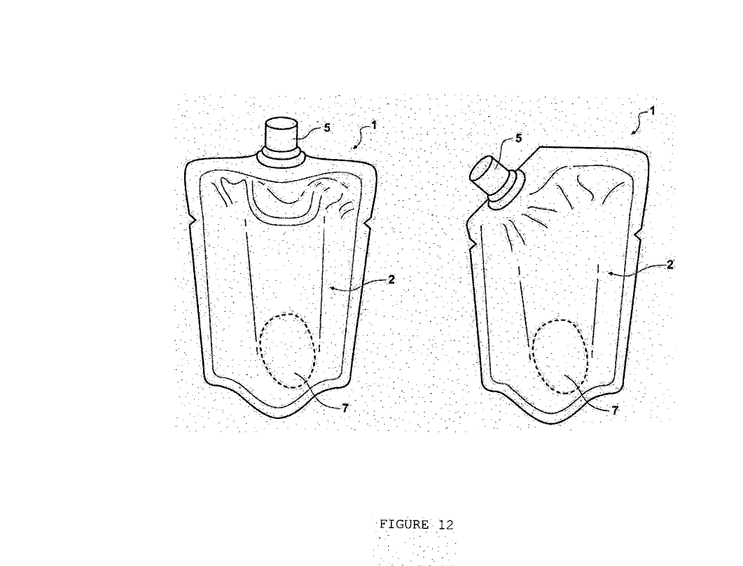

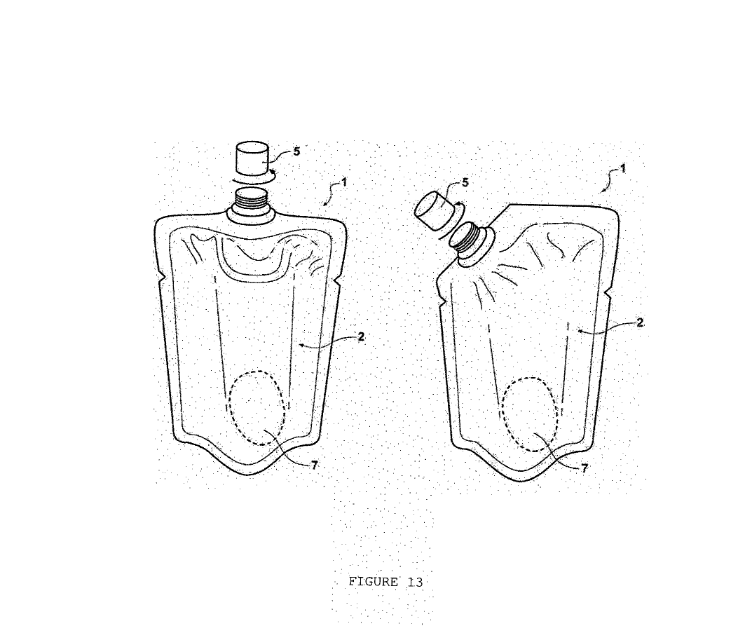

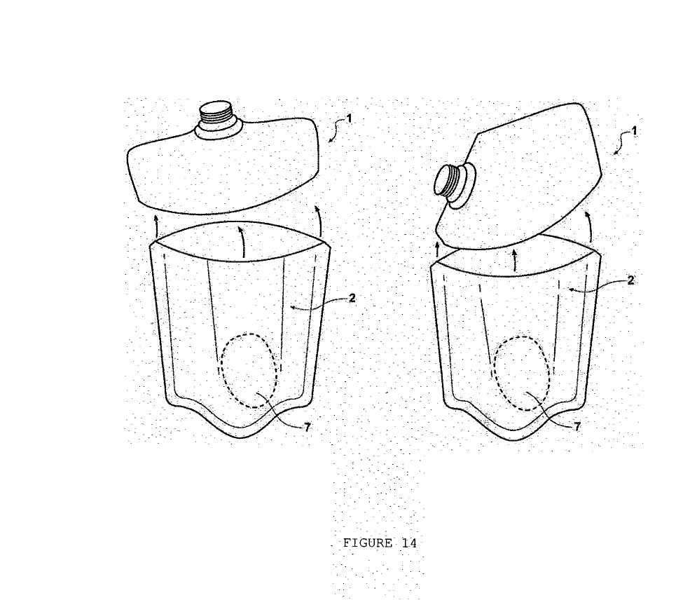

Two alternatives of a third embodiment of the invention are illustrated in FIGS. 12 to 14 of the drawings pages. The figures present a releasably sealed container (1) of the pouch type. The container is formed from two opposing side walls (2) sealed around their periphery with or without the inclusion of a base wall set between the side walls. In this embodiment the first releasable seal (5) may be a screw cap or a stopper. The first releasable seal is released by unscrewing the cap as illustrated in FIG. 13 or removing the stopper. In this embodiment the second releasable seal is provided by tearing open the container as illustrated in FIG. 14. The tearing open of the container is facilitated by a nick or pair of nicks in the periphery where the opposing side walls of the container are sealed together and serves as the second releasable seal.

Examples of harvested produce and storage solution combinations for use in the preparation of the packaged beverage are now described. As already noted the palatability of the resulting beverage will be a matter of subjective opinion. In the following examples any notes in respect of palatability are the opinion of a single consumer and are not intended to imply any universal appeal to consumers. The concentrations of solutes are referred to in terms of percent by weight (w/v). The relationship between solute concentration expressed in these terms and Brix reading is provided for specified solutes, but should not be read as inferring a direct correlation. A Brix reading is a convenient and commonly used means of expressing the soluble solids concentration of whole fruit. For determining fruit tonicity there is an acceptable correlation between Brix reading, soluble solids concentration, and tonicity. As the tonicity of a solution is a function of the molar concentration of solutes in the solution there is no universally acceptable correlation between Brix reading, solute concentration expressed in terms of percent by weight, and tonicity where a range of potential solutes with a wide range of different molecular weights and optical activities are used. Concentrations of solutes in the solutions are provided in the following examples in terms of percent by weight and Brix reading for convenience only. In all cases the objective is to employ a solution with a solute concentration that establishes a neutral water potential, generally a solution that is moderately hypotonic or substantially isotonic solution. The methods provided in the examples can be readily adopted to determine the appropriate combinations of solute and solute concentration to be used in a solution for a particular type of harvested produce whether it be whole fruit or diced root vegetables. Where column heading are absent the composition of the immersion solutions is provided in the left hand column of each table (except where fruit variety is also identified in the table). Brief comments on the characteristics of the immersed fruit and immersion solution following storage are provided in the right hand column of each table. It will be appreciated that these characteristics are a subjective determination and the desired characteristics may vary between individuals and regional markets.

### Examples 1 to 3

Table 1 below shows the relationship between glycerol concentration and Brix:

| Glycerol concentration %(w/v) | Brix reading |
|---|---|
| 1.0 | 1.5 |
| 2.0 | 2.5 |
| 3.0 | 3.4 |
| 4.0 | 4.0 |
| 5.0 | 5.1 |
| 6.0 | 6.0 |
| 7.0 | 7.0 |
| 8.0 | 8.0 |
| 9.0 | 9.0 |
| 10.0 | 10.0 |
| 15.0 | 14.8 |
| 16.0 | 15.8 |
| 17.0 | 16.9 |
| 20.0 | 19.6 |
| City water | 0.2 |
| RO water | 0.0 |

Table 2 shows the relationship between calcium chloride concentration and Brix:

| Calcium chloride concentration %(w/v) | Brix reading |
|---|---|
| 0.5 | 1.0 |
| 1.0 | 1.5 |
| 1.5 | 2.4 |
| 2.0 | 2.8 |
| 2.5 | 3.5 |
| 3.0 | 4.2 |
| 3.5 | 4.6 |
| 4.0 | 5.4 |
| 4.5 | 5.7 |
| 5.0 | 6.8 |

Table 3 shows the relationship between glycerol plus calcium chloride and Brix:

| Glycerol % (w/v) | Calcium chloride % (w/v) | Brix reading |
|---|---|---|
| 1.0 | 1.5 | 3.5 |
| 1.0 | 3.0 | 5.2 |
| 1.0 | 4.5 | 7.0 |
| 2.5 | 1.5 | 5.0 |
| 2.5 | 3.0 | 6.8 |
| 2.5 | 4.5 | 8.5 |
| 5.0 | 1.5 | 7.5 |
| 5.0 | 3.0 | 9.0 |
| 5.0 | 4.5 | 10.8 |
| 7.5 | 1.5 | 9.5 |
| 7.5 | 3.0 | 11.5 |
| 7.5 | 4.5 | 13.0 |
| 10.0 | 1.5 | 12.5 |
| 10.0 | 3.0 | 13.5 |
| 10.0 | 4.5 | 15.0 |

Examples 1 to 3 show that the Brix readings increase with increasing concentrations of glycerol (and other polyhydric alcohols). Addition of calcium chloride and other ions also increases Brix readings.

### Example 4

Braeburn apples purchased from a local supermarket were weighed and placed singly in various solutions and stored for one month at 5° C. At this time the apples were removed from the solutions, dried, weighed, and firmness assessed using a penetrometer.

The Brix of the fruit at time of storage (control fruit) and following storage, as well as the Brix of solution, were assessed using a portable refractometer. All treatments were replicated 5× and the means are presented in Table 4.

Table 4 shows the effect of solution formulation on weight, firmness and Brix of Braeburn apples following one month's storage at 5° C.:

| Treatment | | | | | | | | |
|---|---|---|---|---|---|---|---|---|
| solution | | | Fruit | | | | | |
| Glycerol/ | | | weight | | Soln Brix | | Fruit | Firmness |
| CaCl₂/D-glucose | | | Start/ | | Start/ | | Brix | Kg/Nm |
| % (w/v) | | | Finish | | Finish | | Finish | Finish |
| 3.5 | 0.0 | 0.0 | 185 | 186 | 4.0 | 4.0 | 11.6 | 7.3 |
| 3.5 | 0.0 | 1.5 | 174 | 176 | 5.2 | 5.4 | 11.7 | 7.1 |
| 3.5 | 0.0 | 3.0 | 180 | 180 | 6.6 | 6.6 | 11.0 | 6.9 |
| 3.5 | 1.5 | 0.0 | 187 | 189 | 5.8 | 5.8 | 11.7 | 7.6 |
| 3.5 | 1.5 | 1.5 | 178 | 179 | 7.0 | 6.9 | 12.4 | 7.1 |
| 3.5 | 3.0 | 0.0 | 187 | 187 | 7.4 | 7.3 | 11.8 | 7.6 |
| 3.5 | 3.0 | 1.5 | 184 | 185 | 8.0 | 8.3 | 11.4 | 7.2 |
| 3.5 | 3.0 | 3.0 | 175 | 175 | 9.8 | 10.0 | 10.7 | 8.0 |
| 3.5 | 0.0 | 5.0 | 181 | 182 | 8.0 | 7.9 | 12.5 | 7.1 |
| 3.5 | 0.0 | 10.0 | 187 | 187 | 12.3 | 12.3 | 13.2 | 6.1 |
| 3.5 | 0.0 | 20.0 | 183 | 184 | 18.6 | 18.6 | 12.6 | 6.7 |

| | | |
|---|---|---|
| Control Apples at Start | 12.3 | 6.5 |

The results in Table 4 give an insight into the dynamics of fruit in solution. The Brix of the fruit and the Brix of the solution were each maintained during storage. Fruit firmness increased during storage in the solutions, especially in those solutions having lower Brix readings. As there is no significant change in the wet weight of the fruit before (start) and after (finish) immersion the solution must be hypotonic.

### Example 5

Red Globe grapes purchased from a local supermarket were stored in various solutions for 20 days at 5° C. The weight loss/weight gain and Brix of the grapes and the solutions were recorded prior to and following storage. Table 5 shows the effect of solution on Red Globe grapes during storage for 20 days at 5° C.:

| | Weight | | | |
|---|---|---|---|---|
| | change | Soln Brix | | Fruit Brix |
| Treatment | g (mean) | Start/Finish | | Finish |
| Water | +1.4 | 0.0 | 0.3 | 15.2 split |
| 1% (w/v) glycerol | +0.6 | 1.5 | 1.5 | 17.0 |
| 5% (w/v) glycerol | +1.6 | 5.2 | 5.4 | 15.4 split |
| 7% (w/v) glycerol | +1.0 | 7.3 | 7.3 | 16.3 |
| 10% (w/v) glycerol | +0.7 | 10.0 | 10.0 | 16.0 |
| 15% (w/v) glycerol | +0.1 | 14.6 | 15.00 | 16.8 |
| 20% (w/v) glycerol | +0.2 | 19.4 | 19.6 | 15.3 |
| 15% (w/v) gly + 1.5% (w/v) CaCl₂ | −0.1 | 17.0 | 16.8 | 16.0 |
| 15% (w/v) gly + 3% (w/v) CaCl₂ | −0.2 | 18.5 | 18.2 | 16.6 |
| 15% (w/v) gly + 4.5% (w/v) CaCl₂ | −0.5 | 22.0 | 22.0 | 17.0 |
| 1% CaCl₂ | +1.1 | 1.6 | 2.0 | 15.4 |
| 2.5% CaCl₂ | +1.3 | 3.4 | 3.6 | 14.8 |
| 5.0% CaCl₂ | +0.6 | 6.4 | 6.4 | 15.8 |
| Control Grapes | | | | 18.0 |

In water and at low concentrations of glycerol the grapes took up water from the solution and split. As the solution Brix exceeded that of the grapes the fruit lost weight. Solutions having lower to moderate Brix readings were optimal.

### Example 6

Braeburn apples picked from the orchard in a slightly overripe condition were stored in a solution of 3.5% glycerol with various ions, sugars and polyhydric alcohols added at concentrations of 1% and 2%. The apples were incubated at 2° C. for one month when weight loss/weight gain, firmness and Brix were measured. Five fruit were incubated per treatment and the means are presented in Table 6. Table 6 shows the influence of solution composition on Braeburn apples during storage at 2° C. for one month:

| | | Weight | | | |
|---|---|---|---|---|---|
| | Conc. | Change | Fruit | Firmness | |
| Chemical | (w/v) | (g) | Brix | Kg/Nm | Comments |
| Calcium | 1% | +0.7 | 15.0 | 10.0 | V. crisp, sour |
| nitrate | 2% | +0.8 | 16.0 | 10.0 | V. crisp, sour |
| Calcium | 1% | +3.0 | 14.6 | 8.0 | V. crisp, fresh bite |
| citrate | 2% | +2.0 | 13.4 | 8.0 | Greenish, fresh taste |
| Calcium | 1% | +0.5 | 14.0 | 8.0 | Crisp, fresh and sour |
| gluconate | 2% | 0.0 | 13.8 | 9.0 | Fresh, clean on palate |
| KH₂P0₄ | 1% | +2.3 | 15.0 | 8.0 | V. crisp, fresh fizz |
| | 2% | +0.7 | 13.2 | 9.0 | V. crisp, fresh fizz |
| KH₂PO₄ | 1% | 0.0 | 13.6 | 9.0 | V. crisp, fresh fizz |
| | 2% | −1.3 | 12.6 | 8.5 | V. crisp, fresh fizz |
| Sorbitol | 1% | +0.3 | 14.0 | 8.0 | Sour |
| | 2% | +1.1 | 13.0 | 8.0 | Crisp, sweet&clean |
| Mannitol | 1% | +1.1 | 14.0 | 8.0 | Crisp, sweet&sour |
| | 2% | +0.5 | 12.0 | 6.8 | sour |
| D-glucose | 1% | +1.3 | 13.0 | 8.0 | Crisp, fresh fizz |
| | 2% | +0.9 | 13.2 | 8.0 | Crisp, fresh fizz |
| Inositol | 1% | +0.2 | 12.8 | 8.0 | Fresh, clean on palate |
| | 2% | +0.4 | 12.6 | 7.0 | Green, soft, fresh |
| MgS0₄ | 1% | +0.7 | 12.8 | 7.5 | Fresh, crisp, clean |
| | 2% | −0.3 | 13.0 | 8.2 | Fresh, crisp, green |
| Control | | | 14.0 | 6.8 | Sweet, slightly soft |

The data in Table 6 show how the formulation of the storage solution affects the Brix, firmness and flavor of Braeburn apples. Where polyhydric alcohols are the solutes lower concentrations are favoured. Braeburn apples stored for one month in solutions of 3.5% Glycerol plus 1 and 2% solutions of various salts and sugars were hypotonic and kept the fruit firm and crisp. Solutions of 3.5% Glycerol plus 2% KH₂PO₄ and 2% MgSO₄ appeared to be hypertonic whilst 2% calcium gluconate and 1% KH₂PO₄ appeared to be isotonic. Solutions of 3.5% glycerol plus various salts/sugars are appear to be predominantly hypotonic for the storage of Braeburn apples.

### Example 7

Braeburn apples were stored in a mixture of glycerol, mannitol, sorbitol and propylene glycol with and without calcium chloride. The fruit were stored at 2*C in the solutions for one month. Weight loss/gain, firmness, Brix and flavor attributes were assessed. All treatments were replicated five times. Table 7 shows the influence of solution composition on Braeburn apples during storage at 2° C. for one month:

| Concentration | | | | | |
|---|---|---|---|---|---|
| of each | | | | | |
| of the | Concen- | | | | |
| polyhydric | tration | Weight | | | |
| alcohols | Of CaCl₂ | Change | Fruit | Firmness | |
| (w/v) | (w/v) | (g) | Brix | Kg/Nm | Comments |
| 0.5% | 0% | +3.0 | 9.6 | 7.7 | Crisp, green, |
| | 1.5% | +0.5 | 14.0 | 9.0 | sour |
| | | | | | Very sweet |
| 0.75% | 0% | +5.4 | 12.0 | 8.0 | Crisp, sweet |
| | 1.5% | −0.4 | 13.4 | 9.0 | Crisp, bland |
| 1.0% | 0% | +3.1 | 15.6 | 8.6 | Crisp, sweet |
| | 1.5% | −1.0 | 12.6 | 8.5 | Crisp, sweet, |
| | | | | | refreshing |
| 1.25% | 0% | +1.5 | 10.6 | 7.6 | Greenish, sour |
| | 1.5% | −0.8 | 13.0 | 7.4 | Crisp, sour |
| | | | | | with bite |
| 1.5% | 0% | 0.0 | 12.6 | 8.6 | Crisp, green, |
| | 1.5% | −1.8 | 13.6 | 8.5 | refreshing |
| | | | | | Sweet and sour |

A mixture of polyhydric alcohols (polyols) can be mixed with calcium chloride (CaCl₂) to alter fruit attributes. At all concentrations of polyols without CaCl₂ the apples gained weight consistent with the solutions being moderately hypotonic. Fruit increased overall weight by an average of 2.06 g. At the higher concentrations of polyols with the addition of calcium chloride (CaCl₂) the apples lost weight consistent with the solutions being hypertonic. The addition of 1.5% CaCl₂ to the mixtures of polyhydric alcohols (polyols) at a concentration above 0.5% made the solution weakly hypertonic and the fruit lost an average 0.7 g. As expected CaCl₂ increased fruit firmness (8.5 v 8.1 Kg/m²). However, this effect ceased as the concentration of the mixture of polyhydric alcohols (polyols) exceeded 1%. The results indicate that the addition of a soluble salt such as CaCl₂ to the mixture of polyhydric alcohols (polyols) can pull water from the apples causing a slight loss of weight (approx. 1.5% overall) and change the tonicity of the storage solution from hypotonic to hypertonic. It also demonstrates the complexity of the relationship between fruit and solutions. The addition of soluble salts to the storage solution which have the capacity to move across cell membranes can readily change the dynamics of the storage solution.

### Example 8

Forty overripe Gala apples were purchased from a local supermarket. Fruit had a firmness of 5.8 Kg/Nm and a Brix of 14.2 (mean of 10 fruit).

Twenty fruit were placed in a large plastic container in a solution of 3.5% glycerol, 0.75% calcium chloride and 1% calcium lactate. Air was bubbled into the base of the container using an aquarium pump. The fruit in the solution were stood on the bench at 20° C. for 20 days when the fruit were removed from the solution and tested for firmness and Brix. Ten control fruit were stored on the same bench in a plastic bag. Table 8 shows the influence of storage solution and air on storage parameters of Gala apples:

| | Firmness | Brix of | |
|---|---|---|---|
| Treatment | Kg/Nm | Fruit | Comments |
| Apples at start | 5.8 | 14.2 | Sweet, soft mealy |
| of trial | | | |
| Apples from solution | 7.4 | 12.8 | Firm, greener, less |
| at end of trial | | | sweet |
| Apples from air | 5.3 | 16.0 | Sweet, soft mealy |
| at end of trial | | | |

The trial data indicates that storage of apples in a specific solution at ambient temperature with aeration reversed the ripening process and made the fruit firmer and less ripe. Apples in solution gained weight as indicated by increasing firmness of the cell walls and the hypotonic characteristics of the solution. Apples stored in air continued to lose weight presumably as a consequence of the cell walls losing their integrity and the fruit further ripening. The lack of oxygen as a result of immersion in the storage solution is anticipated to have slowed the metabolism of ripening and evolution of ethylene. The calcium ions have the potential to have induced cell repair.

### Example 9

Table 9 shows the interactions of Braeburn apples and storage media following storage for 7 days at 3° C.:

| | % Weight | Brix Soln | Brix Soln | Brix Fruit |
|---|---|---|---|---|
| | Change | At Start | At End | At End |
| Water Control | +0.12% | 0.0 | 0.0 | 10.3 |
| Glycerol (w/v) | | | | |
| 2.5% | −0.37% | 1.4 | 1.3 | 11.0 |
| 5.0% | +0.09% | 3.6 | 4.0 | 10.4 |
| 10.0% | −0.03% | 7.0 | 7.0 | 10.0 |
| 20.0% | +0.03% | 14.6 | 14.4 | 9.0 |
| 40.0% | −0.31% | 30.0 | 27.0 | 11.0 |
| SUCARYL ™ (w/v)* | | | | |
| 2.5% | +0.18% | 0.0 | 0.0 | 11.4 |
| 5.0% | +0.15% | 0.0 | 0.0 | 9.2 |
| 10.0% | +0.10% | 0.0 | 0.5 | 10.0 |
| 20.0% | +0.17% | 1.2 | 1.2 | 10.0 |
| 40.0% | +0.18% | 2.6 | 2.8 | 10.0 |
| D-glucose (w/v) | | | | |
| 2.5% | +0.09% | 1.6 | 1.8 | 9.8 |
| 5.0% | +0.04% | 4.2 | 4.5 | 10.2 |
| 10.0% | 0.08% | 8.5 | 8.8 | 10.0 |
| 20.0% | 0.02% | 16.2 | 16.4 | 11.2 |
| 40.0% | −0.16% | 28.0 | 27.0 | 11.4 |
| Air Control | −0.16% | — | — | 10.0 |

*SUCARYL ™ (sodium cyclamate 8% w/v, sodium saccharin 0.8% w/v, benzoic acid 0.1% w/v).

Braeburn apples exhibited small changes in weight regardless of the solute type and solute concentration. The Brix of the solution showed little change during storage as did the Brix of the apple. Weight changes in sucaryl were consistent irrespective of concentration.

### Example 10

Table 10a shows the interactions of Red Globe grapes and storage media following storage for 7 days at 3° C.:

| | % Weight | Brix Soln | Brix Soln | Brix Fruit |
|---|---|---|---|---|
| | Change | At Start | At End | At End |
| Water | +9.0% | 0.0 | 0.0 | 14.8 |
| Control | | | | |
| Glycerol | | | | |
| (w/v) | | | | |
| 2.5% | +11.1 | 1.4 | 2.2 | 15.0 |
| 5.0% | +8.4% | 3.6 | 5.0 | 15.6 |
| 10.0% | +3.4% | 7.0 | 9.4 | 15.8 |
| 20.0% | −2.9% | 14.6 | 17.2 | 15.4 |
| 40.0% | −11.3% | 30.0 | 28.6 | 18.6 wrinkled |
| Sucaryl | | | | |
| (w/v) | | | | |
| 2.5% | +9.4% | 0.0 | 0.0 | 11.4 |
| 5.0% | +16.4% | 0.0 | 1.2 | 9.2 small split |
| 10.0% | +12.8% | 0.0 | 2.8 | 10.0 split |
| 20.0% | +10.6% | 1.2 | 3.8 | 10.0 split |
| 40.0% | +8.1% | 2.6 | 5.0 | 10.0 split |
| D- | | | | |
| Glucose | | | | |
| (w/v) | | | | |
| 2.5% | +12.7% | 1.6 | 3.0 | 16.5 |
| 5.0% | +11.4% | 4.2 | 6.4 | 14.2 |
| 10.0% | +5.8% | 8.5 | 11.2 | 14.8 |
| 20.0% | +0.45% | 16.2 | 24.0 | 15.6 |
| 40.0% | −5.3% | 28.0 | 33.0 | 15.6 wrinkled |
| Air | −6.5% | — | — | 14.5-18.0 |
| Control | | | | |

In contrast to Braeburn apples, Red Globe grapes exhibited large gains/losses in weight with solute and solute concentration. Grapes stored in water gained weight. In glycerol the grapes gained less weight as the concentration approached 10% then lost weight. At 40% the grapes became wrinkled. In SUCARYL™ at higher concentrations (10% and above) the grapes gained water and split making the data unreliable. The splitting caused the Brix of the solution to increase as material exited fruit. In D-glucose the weight gain decreased as solute concentration increased, reaching equilibrium at a concentration slightly above 20%. At 40% the grapes lost weight and became wrinkled. In glycerol and in D-glucose the Brix of the solution increased following storage. Table 10b shows the interactions of Red Globe grapes and storage solutions on storage for 20 days at 5° C.:

| | | | | | Brix |
|---|---|---|---|---|---|
| | Weight at | Weight at | Change in | Brix (solution | (fruit at |
| | start (g) | end (g) | weight (g) | at end) | end) |
| Glycerol | | | | | |
| (w/v) | | | | | |
| Water | 11.30 | 12.86 | +1.56 g | 0.0 | 14.62 |
| 2.5% | 12.82 | 14.25 | +1.43 g | 1.4 | 14.25 |
| 5.0% | 13.72 | 14.87 | +1.15 | 3.6 | 15.8 |
| 10.0% | 12.58 | 13.01 | +0.43 | 7.0 | 15.8 |
| 20.0% | 15.33 | 14.89 | −0.44 | 14.6 | 15.4 |
| 40.0% | 14.02 | 12.43 | −1.59 | 30.0 | 18.6 |
| Sucaryl | | | | | |
| (w/v) | | | | | |
| Water | 17.67 | 18.98 | +1.31 g | 0.0 | 15.60 |
| 2.5% | 17.50 | 19.15 | +1.65 g | 0.0 | 15.40 |
| 5.0% | 11.79 | 13.73 | +1.94 | 0.0 | 14.0 |
| 10.0% | 13.52 | 15.52 | +2.00 | 0.0 | 14.4 |
| 20.0% | 17.30 | 19.13 split | +1.83 | 1.2 | 14.0 |
| 40.0% | 14.64 | 15.83 split | +1.19 | 2.6 | 15.3 |
| D-Glucose | | | | | |
| (w/v) | | | | | |
| Water | 14.16 | 15.82 | +1.66 g | 0.0 | 14.40 |
| 2.5% | 17.03 | 19.20 | +2.17 g | 1.6 | 16.5 |
| 5.0% | 19.15 | 21.34 | +2.19 | 4.2 | 14.2 |
| 10.0% | 14.58 | 15.43 | +1.34 | 8.5 | 14.8 |
| 20.0% | 15.43 | 15.50 float | +0.07 | 16.2 | 15.6 |
| 40.0% | 20.09 | 19.02 float | −1.88 | 28.0 | 15.6 |
| Air | 14.28 | 13.34 | −0.94 | 0.0 | 18.4 |

Three Red Globe grapes were placed in solutions of 10% glycerol to which were added various concentrations of CaCl₂ and NaCl. The fruit were stored at 5° C. for 7 days when they were dried and weighed and the Brix of the storage solution and the grapes determined. The object of the experiment was, to determine the tonicity of the various solutions.

| Treatment | Wgt | | | | |
|---|---|---|---|---|---|
| 10% Glycerol plus | (g) | Wgt (g) | Difference | Brix | Brix |
| CaCl₂/NaCl | start | finish | (g) | soln | grapes |
| 10% Glycerol | 41.8 | 42.9 | 1.1 | 8.6 | 16.4 |
| 0.25% CaCl₂ | 35.1 | 36 | 0.9 | 9 | 16 |
| 0.5% CaCl₂ | 33.4 | 34.06 | 0.7 | 9 | 17 |
| 1% CaCl₂ | 33.9 | 34.7 | 0.8 | 9.2 | 16.8 |
| 2% CaCl₂ | 34.2 | 35.0 | 0.8 | 9 | 16.5 |
| 0.25% NaCl | 49.3 | 50.3 | 1.0 | 8.6 | 17.3 |
| 0.5% NaCl | 34.16 | 35.16 | 1.0 | 9 | 15 |
| 1% NaCl | 40.6 | 41.3 | 0.7 | 9.6 | 16 |
| 1.5% NaCl | 43.5 | 44.5 | 1.0 | 8.4 | 15 |
| 2% NaCl | 37.4 | 38.2 | 0.8 | 10.6 | 14.2 |
| 0.25% NaCl/0.25% CaCl₂ | 45.5 | 46.4 | 0.9 | 9 | 16.6 |
| 0.5% NaCl/0.5% CaCl₂ | 32.5 | 33.3 | 0.8 | 9.4 | 16.6 |
| 0.75% NaCl/0.25% CaCl₂ | 43.7 | 43.9 | 0.2 | 9.6 | 16.6 |
| 0.25% NaCl/0.75% CaCl₂ | 37.8 | 38.5 | 0.7 | 9.6 | 17.2 |
| Mean | | | 0.8 | 9.2 | 16.2 |

Red Globe grapes stored for 7 days in solutions of 10% glycerol plus various concentrations of CaCl₂ and NaCl and mixtures thereof gained on average 0.8 g per three fruit. Hence, the storage solutions were moderately hypotonic and kept the fruit firm. The differential in Brix between the grapes and the storage solution was maintained possibly because of the tonicity of the 10% glycerol solution.

### Example 11

Table 11 shows how solution composition can affect the flavour and textural attributes of Nashi pear and apples following storage for 30 days at 5° C.:

| | | Pacific Rose | Braeburn | Granny Smith |
|---|---|---|---|---|
| Solution | Nashi Pear | Apple | Apple | Apple |
| 1.3% SUCARYL ™* | Very sweet, | Sweet, skin | Sour, | Sweet and |
| Glycerol | nice taste and | tough and chewy | crisp, bite | sour |
| Propylene glycol | texture | | | |
| 1% CaCl₂ | | | | |
| 3% Glycerol | Tastes like | Refreshing | Sour, soft | Crisp, sweet |
| 1% SUCARYL ™* | fresh Nashi, | taste, | | refreshing |
| 1% CaCl₂ | wooden skin | skin not obvious | | |
| 3% Propylene glycol | Very sweet, | Bland, skin | Sweet, skin | Sour, bland |
| 1% Glycerol | nice taste and | tough | tough | |
| 1% CaCl₂ | texture | | | |
| 3% SUCARYL ™* | Sweet, | Crisp, nice | Crisp, | Rubbery, |
| 1% Glycerol | excellent | flavour, skin | refreshing, | bland, soft |
| 1% CaCl₂ | taste and | not obvious | nice | |
| | texture | | | |
| 3% SUCARYL ™* | Sweet, nice | Too sweet, skin | Sour, soft | Sour, soft |
| 1% propylene glycol | taste and | tough and chewy | and mushy | and mushy |
| 1% CaCl₂ | texture, | | | |
| | aromatic | | | |

*SUCARYL ™ (sodium cyclamate 8% w/v, sodium saccharin 0.8% w/v, benzoic acid 0.1% w/v).

The observations in Table 11 show how variations in solution composition can alter flavour and textural attributes of fruit. The results obtained for a particular fruit and solution combination were consistent and repeatable.

### Example 12

Zespri Gold and Haywood Green Kiwifruit were placed in solutions which were intended for drinking along with consumption of the fruit. These solutions can also be carbonated and have alcohol added depending upon the desired product. Prior to placement in the solutions the fruit were rinsed in filtered tap water. The water for the solutions was also tap water. Fruit in solutions were kept at 5 to 6° C. for 30 days prior to sampling.

| | |
|---|---|
| 4% Sucaryl + 1% Sorbitol | Fruit and drink taste nice. |
| 3% Sucaryl + 2% Glycerol | Fruit and drink taste nice |
| 3.5% Sucaryl + 1.5% Glycerol | Fruit and drink taste nice |
| 2.5% Sucaryl + 3% Glycerol | Fruit and drink taste nice |
| 2.5% Sucaryl + 2.5% Glycerol | Fruit and drink taste nice |
| 4% Sucaryl + 1% Glycerol | Fruit and drink taste nice |
| 6% Sucaryl + 2% Glycerol | Too sweet/sour |
| 4% Sucaryl + 1% Glycerol + 7.5% | Drink nice, smoky, fruit |
| Grants Whisky | good flavor |
| 4% Sucaryl + 1% Glycerol + 7.5% | Drink nice, fruit good flavor |
| Burbon | |
| 3.5% Equal + 1% Glycerol | Drink sour. Fruit tart but nice |
| 1.75% Sugromax | Drink and fruit nice |
| 4% Sucaryl + 1% Glycerol + 1% D- | Drink too sweet fruit OK |
| Glucose + 0.5% NaCl | |
| Green 3.5% Sucaryl + 1% Glycerol | Drink and fruit nice |
| +0.5% Ascorbic acid | Nice drink and fruit with bite |
| +7.5% Brandy | As above |
| +7.5% Gin | As above |
| +7.5% Grappa | Drink whisky like. Fruit nice |
| | sharp taste. |
| Gold. 3% Sucaryl + 2% Glycerol + | Sweet but nice |
| 2% Propylene Glycol + 1% D-Glucose | |
| +0.5% Ascorbic acid | Drink sharp taste, fruit sweet |
| +7.5% Gin | Both drink and fruit nice flavor |
| +7.5% Grappa | V nice drink and fruit. |
| 3.5% Sucaryl + 1% Glycerol + 7.5% | Both drink and fruit nice flavor |
| Rum Gold | |
| 4% Sucaryl + 3% Glycerol + 3% | Drink nice. Fruit sweet with zing |
| Propylene Glycol + 1% D-glucose | |
| +7.5% Brandy | Drink and fruit nice. |
| +7.5% Cointreau | Drink whisky like. fruit with |
| | zing |
| 5% Glycerol + 2.5% Sucaryl + 0.5% | Drink strange flavor. Fruit sour, |
| NaCl + 0.5% CaCl | awful |
| 3% Sucaryl + 1% Glycerol | Drink and fruit very nice |
| 3.5% Sucaryl + 5% Glycerol | Drink aromatic flavor. Fruit nice |
| 1.5% Sucaryl + 1.5% Glycerol + | Drink sour. Fruit good taste |
| 1.5% Propylene Glycol | |
| 2% Sucaryl + 3% Glycerol + 2% | Drink strange flavor. Fruit nice |
| Propylene Glycol + 1% D-glucose | esp. Gold. |
| 7.5% Glycerol + 1% NaCl | Nice sweet/sour drink and fruit |
| 3% Sucaryl + 2% Glycerol + | Very nice drink and fruit |
| 2% Propylene Glycol + 1% D-glucose. | |
| 6% Sucaryl + 2% Glycerol + o. | Drink strange flavor |
| 2% Sucaryl + 1.5% Glycerol + 1.5% | Fruit sweet/sour nice |
| Propylene Glycol + 2% D-glucose | |
| Green. 5% Glycerol + 2.5% Sucaryl + | Too sour |
| 1% D-glucose | |
| Green. 7.5% Glycerol + 1% D-glucose | Fruit nice, drink sweet |
| 4% Glycerol + 3% Sucaryl + | Drink and fruit nice(hint salty) |
| 3% Propylene Glycol + 1% NaCl | |
| 4% Glycerol + 3% Sucaryl + | As above. |
| 3% Propylene Glycol + 2% | |
| D-Glucose + 1% NaCl | |
| 3.5% Glycerol + 1.5% D-Glucose | Drink not nice. Fruit nice |
| 2.5% Sucaryl + 5% Propylene Glycol + | Drink not nice. Fruit nice. |
| 0.5% NaCl + 0.5% CaCl₂ | |
| 2% Glycerol + 1.5% Sucaryl + 1.5% | Fruit nice |
| Propylene Glycol + 0.5% NaCl + 0.5% | |
| CaCl₂ | |
| 5% Glycerol + 1% NaCl + 0.5% Citric | Drink ok.. Fruit bitter after taste. |
| acid + 0.5% K₂HPO₄ + 2.5% | |
| D-Glucose | |
| 5% Glycerol + 5% D-Glucose + 0.5% | Drink ok. Fruit too sweet. |
| Citric acid + 1% K₂HPO₄ | |

### Example 13

Red, green and black table grapes can be carbonated and alcohol added depending upon the desired product. Fruit were washed and treated as detailed above for kiwifruit.

| | |
|---|---|
| 10.5% Glycerol + 1.5% Sorbitol + 1% | Fruit and drink excellent. |
| CaCl₂ | |
| 5% Glycerol + 5% D-Glucose + 0.5% | Fruit and drink excellent. |
| Citric acid + 1% K₂HPO₄ + 1% CaCl₂ | |
| 10.5% Glycerol + 2% Sorbitol | Fruit and drink excellent |
| 8% Sucaryl + 2% Glycerol + 2% Sorbitol | Fruit and drink excellent |
| 4.5% Sucaryl + 3% Glycerol + 2% Sorbitol | Fruit and drink excellent |
| 6% Sucaryl + 4% Glycerol + 2% Sorbitol | Fruit and drink excellent |
| 5% Sucaryl + 5% Glycerol + 1% Sorbitol | Fruit and drink excellent |
| 3.3% each Sorbitol, Sucaryl & Glycerol | Fruit and drink excellent |
| 6% Sucaryl + 4% Sorbitol | Fruit and drink excellent |
| 6% Sucaryl + 4% Sorbitol + 1% Glycerol | Fruit and drink excellent |
| 10.5% Glycerol + 1% D-Glucose | Drink bland. |
| | Fruit crisp excellent |
| +7.5% Gin | Drink like gin & water. |
| | Fruit firm excellent |
| +7.5% Vodka | Drink bland. Fruit firm |
| | nice |
| +7.5.% Brandy | Drink like Brandy &Water. |
| | Fruit firm nice |
| +7.5% Cointreau | Drink bland, sour. |
| | Fruit sweet, bitter |
| 10.5% Glycerol + 1% CaCl₂ | Drink sour. |
| | Fruit crisp sweet |
| +7.5% Gin | Drink bitter. Fruit nice |
| +7.5% Vodka | Drink v bitter. Fruit nice |
| +7.5.% Brandy | Drink vv bitter. Fruit nice |
| +7.5% Cointreau | Drink vv bitter. |
| | Fruit sweet nice |
| 3% Glycerol + 2% Sucaryl + 2% | Drink tastes alcoholic. |
| Propylene Glycol + 1% D-Glucose | Fruit split. |
| ++7.5% Gin | Drink excellent. |
| | Fruit excellent |
| +7.5% Vodka | Drink excellent. |
| | Fruit outstanding |
| +7.5.% Brandy | Drink excellent. |
| | Fruit outstanding |
| +7.5% Cointreau | Drink excellent. |
| | Fruit excellent |

Looking at CaCl₂ and NaCl effects in association with 10% glycerol.

| | |
|---|---|
| +1% CaCl₂ | Drink unsuitable. Fruit firm excellent |
| +1% NaCl | Drink unsuitable. Fruit sweet |
| +0.25% NaCl + 0.75% CaCl₂ | Drink unsuitable. Fruit sweet, |
| | astringent |
| +0.5% NaCl + 0.5% CaCl₂ | Drink unsuitable. Fruit sweet |
| +0.75% NaCl + 0.25% CaCl₂ | Drink unsuitable. Fruit sweet |
| +0.5% CaCl₂ | Drink unsuitable. Fruit sweet |
| +0.5% NaCl | Drink unsuitable. Fruit very firm, sweet |
| +0.25% NaCl + 0.25% CaCl₂ | Drink unsuitable. Fruit firm sweet |
| +0 Ca & Na | Drink unsuitable. Fruit chewy |
| +1.5% NaCl | Drink unsuitable. Fruit chewy |
| +2% NaCl | Drink unsuitable. Fruit chewy, astringent |
| 12.5% Glycerol | Drink bland. Fruit crisp sweet |
| +1.5% CaCl₂ | Drink unsuitable. Fruit v crisp nice |
| +3% CaCl₂ | Drink unsuitable. Fruit firm crisp |
| +4.5% CaCl₂ | Drink unsuitable. Fruit soft little |
| | flavor |
| 15% Glycerol | Drink unsuitable. Fruit OK |
| 15% Glycerol + 1.5% CaCl₂ | Drink unsuitable. Fruit crisp sweet |
| 2.5% ea Glycerol + | Drink unsuitable. Fruit firm sweet |
| mannitol + sorbitol + | |
| propylene glycol + | |
| 1.5% CaCl₂ | |
| 12.5% Propylene glycol | Drink unsuitable. Fruit firm slightly |
| | sour |
| 12.5% Sorbitol | Drink unsuitable. Fruit firm, sweet |
| 10.5% Glycerol | Drink unsuitable. Fruit firm sweet |
| +1.5% Ca lactate | Drink unsuitable. Fruit crisp, |
| | chewy, sour |
| +1.5% Ca nitrate | Drink unsuitable. Fruit crisp, nice |
| +1.5% Ca citrate | Drink unsuitable. Fruit crisp, |
| | refreshing |
| +1.5% D-Glucose | Drink unsuitable. Fruit crisp, |
| | refreshing |
| +1.5% Fructose | Drink unsuitable. Fruit crisp, |
| | refreshing |
| +1.5% MgSO₄ | Drink unsuitable. Fruit crisp, sweet |
| +1.5% Sorbitol | Drink unsuitable. Fruit crisp, nice |
| +1.5% K₂HP0₄ | Drink unsuitable. Fruit firm, crisp, |
| | nice |
| +1.5% KH₂PO₄ | Drink unsuitable. Fruit firm, crisp |
| | refreshing |
| +1.5% Tartaric acid | Drink unsuitable. Soft, watersoaked, |
| | strange taste |
| +1.5% Citric acid | Drink unsuitable. Fruit firm, sweet |
| +1.5% Malic acid | Drink unsuitable. Fruit firm sweet |
| | raison taste |
| +1.5% Galactose | Drink unsuitable. Fruit firm nice taste |
| +3.0% Fructose | Drink unsuitable. Fruit firm, crisp, |
| | nice |

### Example 14

Root ginger is washed then sliced vertically into sections 1-2 cm long and placed in solutions. Carbonation helps the extraction of flavor especially when the container is opened. This makes a refreshing drink and the ginger is not consumed.

| | |
|---|---|
| 4% Sucaryl + 1% Sorbitol | Drink nice |
| 3% Sucaryl + 2% Glycerol | Drink nice |
| 3.5% Sucaryl + 1.5% Glycerol | Drink nice |
| 2.5% Sucaryl + 3% Glycerol | Drink nice |
| 2.5% Sucaryl + 2.5% Glycerol | Drink nice |
| 4% Sucaryl + 1% Glycerol | Drink nice |

### Example 15

Packaged beverages including citrus are designed to enable the citrus oils from the skin to diffuse into solutions to make a natural flavored drink. The solutions may be carbonated or supplemented with alcohol or both. The solutions enter the fruit making it sweet and suitable for eating. Because of the structure of citrus fruit, in that the skin is discrete from the inner segments, the principles governing the movement of solutes and water across membranes outlined in the detailed description do not apply. Therefore concentrations of solutes for suspension of the fruit do not necessarily reflect the Brix of the fruit concentrations. Solutions are therefore tailored to extract maximum flavor from the skin.

Lemons & Limes

| | |
|---|---|
| 3% Sucaryl + 3% Sorbitol + 1% Glycerol | Fruit and drink excellent |
| 4% Sucaryl + 1% Sorbitol | Fruit and drink excellent |
| 4% Sucaryl + 1% glycerol + 1% Sorbitol | Fruit and drink excellent |
| 3.5% Sucaryl + 1.5% Glycerol | Fruit and drink hint sour |
| 3% Sucaryl + 2% Glycerol | Fruit and drink excellent |
| 2.5% Sucaryl + 3% Glycerol | Fruit and drink sharp taste |
| 2.5% Sucaryl + 2.5% Glycerol | Fruit and drink excellent |
| 4% Sucaryl + 1% Glycerol | Fruit and drink excellent |
| +7.5% Gin | Drink excellent. Fruit sweet |
| +7.5% Cointreau | Fruit and drink excellent |
| +7.5% Vodka | Fruit and drink excellent |
| 4% Sucaryl + 3% Glycerol + 3% Propylene | Drink hint sour, fruit sweet |
| Glycol + 1% D-Glucose | |
| +7.5% Vodka | Fruit and drink excellent |
| 3.5% Sucaryl + 5% Glycerol | Fruit and drink excellent |
| +7.5% Gin | Fruit and drink excellent |
| | some bite |
| 4% Sucaryl + 1% Glycerol + 10% Vodka. | Drink and Fruit hint sour |
| 2% Sucaryl + 1.5% Glycerol + 1.5% | Fruit and drink sour |
| Propylene Glycol + 2% D-Glucose | |
| +7.5% Gin | Fruit and drink sour |
| 3% Sucaryl + 1% Glycerol | Fruit and drink excellent |
| +7.5% Gin | Fruit and drink excellent |
| | with bite |
| 1.5% Sucaryl + glycerol + propylene | Like lemon/lime water, |
| Glycol | fruit nice |
| +7.5% Gin | Drink sour, fruit bitter |
| 3% Glycerol + 2% Sucaryl + 2% | Drink poor, |
| Propylene Glycol + 1% D-Glucose | fruit sour |
| +7.5% Gin | Drink like lemon water, |
| | fruit sour |
| 7.5% Glycerol + 1% NaCl | Strange drink and |
| | fruit flavor |
| +7.5% Gin | As above |
| 4% Glycerol + 3% Sucaryl + 3% Propylene | Bitter drink and fruit. |
| Glycol + 1% D-Glucose | |
| +7.5% Gin | Too sour |
| 2% Glycerol + 1.5% Sucaryl + 1.5% | Fruit and drink nice |
| Propylene Glycol + 2% D-Glucose | |
| +10% Gin | Fruit and drink nice |
| +1% NaCl | Drink salty, fruit vv sour |
| +1% CaCl | As above |
| +0.5% NaCl + 0.5% CaCl | Drink hint salt, fruit glassy |

Oranges

| | |
|---|---|
| 5% Glycerol + 0.5% CaCl₂ + 0.5% NaCl | Drink unsuitable. Fruit excellent |
| 3% Glycerol + 1% Prop. Gly + 1% Sucaryl + | Drink unsuitable. Fruit sharp, nice |
| 0.5% CaCl₂ + 0.5% NaCl | flavor |
| 2% Glycerol + 1.5% Prop. Gly + 1.5% | As above |
| Sucaryl + 0.5% CaCl₂ + 0.5% NaCl | |
| 3% Glycerol + 2% Sucaryl | Drink weak flavor. Fruit as above |
| 3% Glycerol + 2% Sucaryl + 1% CaCl₂ | Drink sour, fruit excellent |
| 3% Glycerol + 2% Sucaryl + 1% NaCl | Drink sour. Fruit easy peel, not as |
| | sweet |
| 3% Glycerol + 2% Sucaryl + 0.5% NaCl + | As above |
| 0.5% CaCl₂ | |
| 5% Glycerol + 0.5% NaCl + 0.5% CaCl₂ + | Fluid sour, fruit sour like grapefruit |
| 4% Vodka | |
| 3% Glycerol + 2% Sucaryl + 0.5% NaCl + | Drink sweet, strong orange. Fruit |
| 0.5% CaCl₂ + 4% Vodka. | excellent |
| 2% Glycerol + 2% Sucaryl + 2% D-Glucose + | Fruit and drink excellent |
| 7.5% Vodka | |
| +10% Vodka | As above, more zing |
| 2% Glycerol + 1.5% Sucaryl + 1.5% | As above hint sweeter |
| Prop. Gly + 2% D-Glucose + 7.5% Vodka | |
| +10% Vodka | As above, more zing |
| 2% Glycerol + 1.5% Sucaryl + 1.5% | Drink hint salty, fruit nice bite |
| Prop. Gly + 2% D-Glucose + 1% NaCl + 7.5% | |
| Vodka | |
| 2% Glycerol + 1.5% Sucaryl + 1.5% | Drink yellow, bitter, grapefruit like, fruit |
| Prop. Gly + 2% D-Glucose + 1% CaCl₂ + | sweet/sour |
| 7.5% Vodka | |
| 2% Glycerol + 1.5% Sucaryl + 1.5% | |
| Prop. Gly + 2% D-Glucose + 0.5% CaCl₂ + | |
| 0.5% NaCl | |
| +7.5% Vodka | Drink too sweet, hint sour. Fruit nice |
| 2% Glycerol + 1.5% Sucaryl + 1.5% | Drink and fruit too strong |
| Prop. Gly + 2% D-Glucose + 15% Vodka | |
| 1.5% Glycerol + 1.5% Sucaryl + 1.5% | Drink hint grapefruit. Fruit bland |
| Prop. Gly + 1.5% D-Glucose + 10% Vodka | |
| 2% Glycerol + 1.5% Sucaryl + 1.5% | Drink and fruit excellent |
| Prop. Gly + 2% D-Glucose + 10% Cointreau. | |
| 2% Glycerol + 1.5% Sucaryl + 1.5% | Drink nice, hint of salt, fruit |
| Prop. Gly + 2% D-Glucose + 0.5% NaCl + | excellent |
| 10% Cointreau | |
| 2% Glycerol + 1.5% Sucaryl + 1.5% | |
| Prop. Gly + 2% D-Glucose + 0.5% NaCl + | |
| +0.5% CaCl₂ + 10% Cointreau | Drink nice, hint salt, fruit excellent |
| | (need 0.15% Na/Ca). |
| 3% Sucaryl + 3% Sorbitol + 1% Glycerol | Fruit and drink excellent |
| 4% Sucaryl + 1% Sorbitol | Fruit and drink excellent |
| 4% Sucaryl + 1% glycerol + 1% Sorbitol | Fruit and drink excellent |
| 4% Sucaryl + 1% Glycerol | Fruit and drink excellent |

Mandarins

| | |
|---|---|
| 4% Sucaryl + 1% glycerol + 1% Sorbitol | Fruit and drink nice |
| 4% Sucaryl + 1% glycerol | Fruit and drink nice, hint sour |

### Example 16

Apples and pears store well in solutions and can be manipulated to express different flavors. Each variety exhibits a different response (drink and fruit flavor) to a solution. Specific solutions have been developed for individual varieties and the particular flavor and texture sought. Indicative results from the trial of a sample of pip fruit is given below. European and Nashi pears are quite different and require different treatments.

Peckham Pears

| | |
|---|---|
| 3.5% Glycerol | Drink bland. Fruit crisp, bland |
| 3.5% Glycerol + 1% CaCl₂ | Drink sour. Fruit crisp, nice flavor |
| 3.5% Glycerol + 1.5% CaCl₂ | Drink sour. Fruit crisp, surface 20% |
| | brown |
| 5% Glycerol | Drink bland. Fruit v green, bland |
| 5% Glycerol + 1% CaCl₂ | Drink sour. Fruit v sweet, sour. Surface |
| | 75% brown |
| 5% Glycerol + 1.5% CaCl₂ | Drink sour. Fruit sour, surface brown |
| 7% Glycerol | Drink sweet. Fruit v sweet |
| 7% Glycerol + 1% CaCl₂ | Drink bland. Fruit green, bland |
| 7% Glycerol + 1.5% CaCl₂ | Drink sour. Fruit green bland |
| 1.25% Glycerol + mannitol + sorbitol + | Drink bland. Fruit green, sweet/sour |
| prop. gly | |
| 1.25% Glycerol + mannitol + sorbitol + | Drink sour. Fruit crisp, nice taste |
| prop. gly + 1% CaCl₂ | |
| 4.5% Mannitol | Drink sweet. Fruit crisp, nice |
| 4.5% Mannitol + 1% CaCl₂ | Drink bland. Fruit sweet, nice |
| 4.5% Sorbitol | Drink sweet. Fruit fizz, good taste |
| 4.5% Sorbitol + 1% CaCl₂ | Drink bland. Fruit nice taste, surface |
| | brown |
| 4.5% Propylene Glycol | Drink sour. Fruit water soaked. |
| 4.5% Propylene Glycol + 1% CaCl₂ | Drink sour. Fruit sweet/sour, awful |
| 4.5% Glycerol + 1% Ca nitrate | Drink sour. Fruit crisp, green |
| 4.5% Glycerol + 1% D-Glucose | Drink sweet. Fruit soft, sweet |
| 3% Sucaryl + 1% Glycerol + 5% Grappa | Fruit and drink excellent |
| 1.5% Glycerol + 1.5% propylene glycol + | Fruit and drink excellent |
| 1.5% Sucaryl + 5% Grappa | |
| 4% Sucaryl + 1% Glycerol + 5% Grappa | Fruit and drink excellent |
| 1.5% Glycerol + 1.5% propylene glycol + | Better than 21 |
| 1.5% Sucaryl + 7.5% Grappa | |
| 7.5% Glycerol | Drink non descript. Fruit sweet |
| 5.5% Glycerol + 1% CaCl₂ | Drink sour. Fruit firm |
| 5.5% Glycerol + 1% NaCl | Drink sour. Fruit green fizz, nice |
| 5.5% Glycerol + 0.5% NaCl/CaCl₂ | Drink non descript. Fruit green, nice |
| 1.5% Glycerol + prop. glycol + Sucaryl | Drink nice alcohol taste. Fruit firm, |
| | nice |
| 1.5% Glycerol + prop. glycol + Sucaryl + | As above, fruit firmer |
| 1% D-glucose | |
| 3% Sucaryl + 1.5% Glycerol | Drink and fruit nice |
| 3% Glycerol + 1% CaCl₂ + 0.5% Citric | Drink sour. Fruit firm with bite |
| acid + 1% K2HP04 + 1% Sucaryl | |
| 5.5% Glycerol + 7.5% Vodka | Drink sour. Fruit firm, sour |
| 5.5% Glycerol + 7.5% Brandy | Drink sour. Fruit ok |
| 4% Sucaryl + 1% Glycerol | Fruit and drink nice |
| 4% Sucaryl + 1% Glycerol + 10% Brandy | Drink and fruit nice. |
| 4% Sucaryl + 1% Glycerol + 10% Vodka | Drink and fruit nice |
| 4% Sucaryl + 1% Glycerol + 7.5% Grappa | Drink and fruit nice |

Nashi Pears

| | |
|---|---|
| 3% Sucaryl + 1% Glycerol + 2.5% Grappa | Drink and fruit very nice |
| 3% Sucaryl + 1% Glycerol + 5.0% Grappa | Drink and fruit very nice |
| 3% Sucaryl + 1% Glycerol | Drink and fruit very nice |
| 5% Glycerol + 1% CaCl | Drink sour. Fruit bland |
| 3% Glycerol + 2% Sucaryl + 1% CaCl | Drink bland. Fruit bland |
| 3% Glycerol + 2% Sucaryl + 1% NaCl | Drink bland. Fruit soft |
| 3% Glycerol + 2% Sucaryl + 0.5% NaCl + | Drink bland. Fruit fresh clean taste |
| 0.5% CaCl₂ | |
| 3% Glycerol + 0.5% NaCl + 0.5% CaCl₂. | Drink bland. Fruit fresh clean taste |
| 5% Glycerol + 0.5% NaCl + 0.5% CaCl₂ | Drink bland. Fruit fresh clean taste |
| 3% Glycerol + 1.5% Sucaryl + 1.5% | Drink bland. Fruit crisp v. nice |
| Prop. gly + 1% CaCl₂ | |
| 3% Glycerol + 1.5% Sucaryl + 1.5% | Drink bland. Fruit crisp v. nice |
| Prop. gly + 1% NaCl | |
| 3% Glycerol + 1.5% Sucaryl + 1.5% | Drink bland. Fruit soft |
| Prop. gly + 0.5% NaCl + 0.5% CaCl₂ | |
| 3% Glycerol + 2% Sucaryl + 1% K₂HPO₄ | Drink OK. Fruit crisp nice flavor |
| 5% Glycerol + 1% K₂HP0₄ | Drink bland. Fruit crisp nice flavor |
| 3% Glycerol + 1.5% Sucaryl + 1.5% | Drink bland. Fruit crisp, bland |
| Prop. gly + 1% K₂HPO₄ | |
| 1.3% Glycerol + 1.3% Sucaryl + 1.3% | Drink bland. Fruit sweet, v. nice |
| Prop. gly + 1% CaCl₂ | |
| 3% Glycerol + 1% Sucaryl + 1% CaCl₂ | Drink bland. Fruit typical nashi |
| 3% Prop. gly + 1% Sucaryl + 1% CaCl₂ | Drink unsuitable. Fruit v. sweet, nice |
| 3% Sucaryl + 1% Glycerol + 1% CaCl₂ | Drink unsuitable. Fruit excellent |
| 3% Sucaryl + 1% Prop. gly + 1% CaCl₂ | Drink unsuitable. Fruit nice, aromatic. |
| 5% Glycerol + 2% CaCl₂ | Drink unsuitable. Fruit firm, very nice |
| 3.5% Glycerol + 1.5% CaCl₂ | Drink unsuitable. Fruit excellent |
| | texture, taste |
| 3.5% Glycerol + 2.0% CaCl₂ | Drink unsuitable. Fruit excellent |
| | texture, taste |
| 4% Glycerol + 2.0% CaCl₂ | Drink unsuitable. Fruit crisp, excellent |
| | taste |
| 4.5% Glycerol + 1.5% CaCl₂ | Drink unsuitable. Fruit crisp, excellent |
| | taste |
| 5.5% Glycerol + 1.5% CaCl₂ | Drink unsuitable. Fruit crisp, excellent |
| | taste |
| 5.5% Glycerol + 2 CaCl₂ | Drink unsuitable. Fruit crisp, excellent |
| | taste |
| 4.5% Propylene Glycol | Drink sour. Fruit water core |
| 4.5% Sorbitol | Drink sweet. Fruit sour |
| 4.5% Mannitol | Drink sweet. Fruit sour |

Results for a selection of apple varieties are presented. It will be recognised that different permutations are available depending on the variety and whether a particular flavour of fruit and/or drink is required, optionally carbonated or with alcohol.

Apples

| | | |
|---|---|---|
| Jazz | 4% Glycerol + 1% K₂HP0₄ | Fruit crisp excellent |
| | | flavor |
| Pink Lady | 4% Glycerol + 1% K₂HP0₄ | Drink bland. Fruit nice |
| Pink Lady | 4% Sucaryl + 1% Glycerol | Drink nice. Fruit |
| | | excellent |
| Pink Lady | 4% Sucaryl + 1% D-Glucose | Drink sour. Fruit sour, |
| | | soft |
| Pink Lady | 4% Sucaryl + 3% Sucaryl + | Drink nice. Fruit |
| | 1% D-Glucose | sweet/bite |
| Pink Lady | 4% Equal + 1% Glycerol | Drink sweet/bitter. Fruit |
| | | sweet/bite |
| Pink Lady | 5% Glycerol + 1% CaCl₂ + | Drink sour. Fruit sour |
| | 1% K₂HPO₄ + 1% D-Glucose + | |
| | 0.5% Citric Acid | |
| Braeburn | 4% Sucaryl + 1% Glycerol | Fruit and drink excellent |
| Braeburn | 4% Equal + 1% Glycerol | Drink v. sour. Fruit |
| | | crisp, excellent |
| Braeburn | 2% Sugromax + 1% Glycerol | Drink v. sweet. Fruit |
| | | crisp, nice |
| Granny | 4% Sucaryl + 1% Glycerol | Drink and fruit excellent |
| Smith. | | |
| Braeburn | 3% Sucaryl + 1% Glycerol | Fruit and drink excellent |
| Braeburn | 3% Sucaryl + 1% Glycerol + | Fruit and drink excellent |
| | 0.5% Peppermint | |
| Braeburn | 3% Sucaryl + 1% Glycerol + | Fruit and drink excellent |
| | 5% Grappa | |
| Braeburn | 3% Sucaryl + 1% Glycerol + | Fruit and drink aniseed |
| | 5% Opal Nera | nice |
| Braeburn | 3% Sucaryl + 1% Glycerol + | Fruit and drink nice |
| | 7.5% Brandy | |
| Braeburn | 3% Sucaryl + 1% Glycerol + | Fruit and drink nice |
| | 7.5% Grappa | |
| NZ Beauty. | 4% Sucaryl + 1% Glycerol + | Fruit and drink excellent |
| | 0.2% Peppermint | |
| Jazz | 3% Sucaryl + 1% Glycerol + | Drink salty, apple sweet |
| | 0.5% CaCl₂/NaCl | |
| Jazz | 3% Sucaryl + 1% Propylene | Nothing special |
| | gly + 0.5% CaCl₂/NaCl | |
| Jazz | 4.5% Glycerol + 1% K₂HPO₄ | Drink bland. Fruit crisp |
| | | nice |
| Jazz | 4% Glycerol + 1% D-Glucose + | Drink bland. Fruit crisp |
| | 0.5% NaCl | v nice |
| Jazz | 3% Sucaryl + 1% Glycerol + | Drink and fruit excellent |
| | 7.5% Grappa | |
| Sunrise | 5% Glycerol + 1% CaCl + | Fruit excellent |
| | 0.5% citric + 1% K₂HPO₄ + | |
| | 5% D-Glucose | |
| Jazz | 4% Prop. gly + 0.25% NaCl + | Fruit crisp, nice |
| | 0.75% CaCl₂ | |
| Jazz | 3% Sucaryl + 1% Prop. gly + | Fruit crisp, nice |
| | 0.5% Na/CaCl₂ | |
| Jazz | 4% Glycerol + 0.5% Na/KCl | Strange flavors |
| Jazz | 3% Sucaryl + 1% Glycerol + | Strange flavors |
| | 0.5% Na/KCl | |
| Braeburn | 4% Glycerol + 0.5% Ca/NaCl | Sour Crisp |
| Braeburn | 4% Glycerol + 0.25% Ca + | V Crisp, fresh |
| | 0.75% NaCl | |
| Braeburn | 4% Glycerol + 0.75% Ca + | V Crisp, fresh, bite |
| | 0.25% NaCl | |
| Braeburn | 4% Glycerol + 1% CaCl₂ | Fruit Crisp |
| Braeburn | 4% Glycerol + 1% NaCl | Fruit Crisp |
| Braeburn | 4% Glycerol + 1% NaCl + 1% | Woody, chewy, softer |
| | CaCl₂ | |
| Pacific Rose | 4% Glycerol + 0.5% Ca/NaCl | Sweet Crisp |
| Pacific Rose | 4% Glycerol + 0.25% Ca + | V Crisp, fresh |
| | 0.75% NaCl. | |
| Pacific Rose | 4% Glycerol + 0.75% Ca + | V Crisp, fresh, sweet |
| | 0.25% NaCl | |
| Pacific Rose | 4% Glycerol + 1% CaCl₂ | Fruit Crisp |
| Pacific Rose | 4% Glycerol + 1% NaCl | Fruit Crisp |
| Pacific Rose | 4% Glycerol + 1% NaCl + 1% | Woody chewy, softer |
| | CaCl₂ | |
| Pacific Rose | 3% Glycerol + 1% Sucaryl + | refreshing skin not |
| | 1% CaCl₂ | obvious |
| Pacific Rose | 1% Glycerol + 3% Sucaryl + | refreshing skin not |
| | 1% CaCl₂ | obvious |
| Braeburn | 3.5% Glycerol + 1.5% D- | Crisp, sweet, excellent |
| | Glucose + 0.5% CaCl₂ | |
| Braeburn | 3.5% Glycerol + 1.5% D- | Crisp, sweet, excellent |
| | Glucose | |
| Braeburn | 4% Propylene Glycol + 1% | Crisp, Real bite |
| | CaCl | |
| Braeburn | 2% Glycerol + 2% Sucaryl + | Crisp, sharp, excellent |
| | 0.5% CaCl₂ | |
| Braeburn | 3.5% Glycerol + 1% K₂HPO₄ | Crisp, refreshing |
| Braeburn | 1.25% | Crisp, firm, sharp taste |
| | Prop. gly, Sucaryl, glycerol + | |
| | 0.5% CaCl₂ | |
| Braeburn | 3.5% Glycerol + 1% | Fruit crisp and |
| | CaGluconate | refreshing |
| Braeburn | 4.5% Glycerol + 1% K₂HPO₄ | Fruit crisp and |
| | | refreshing |
| Braeburn | 3.5% Glycerol + 1% KH₂PO₄ | Fruit crisp and |
| | | refreshing |
| Braeburn | 3.5% Glycerol + 1% CaCl₂ + | Fruit crisp and |
| | 1.5% D-Glucose | refreshing |
| Braeburn | 3.5% Glycerol + 1.5% MgSO₄ | Fruit crisp, sweet/sour, |
| | | bite |
| Braeburn | 3.5% Prop. Glycol + 1.5% | Fruit crisp, sharp taste |
| | CaCl₂ | |
| Braeburn | 5% Mannitol | Fruit sweet, soft |
| Braeburn | 5% Mannitol + 1.5% CaCl₂ | Fruit pink, soft |
| Braeburn | 5% Sorbitol | Fruit soft, chewy. |
| Braeburn | 5% Sorbitol + 1.5% CaCl₂ | Fruit soft, sour |
| Braeburn | 5% Glycerol | Fruit crisp |
| Braeburn | 5% Glycerol + 1.5% CaCl₂ | Fruit crisp and |
| | | refreshing |
| Braeburn | 0.75% Glycerol, Mannitol, | Fruit crisp and |
| | sorbitol, prop. glycol | refreshing |
| Braeburn | 1% Glycerol, Mannitol, | Fruit v crisp and |
| | sorbitol, prop. glycol + | refreshing |
| | 1.5% CaCl | |
| Gala | 4.5% Glycerol | Fruit sweet, bland. |
| Gala | 4.5% Glycerol + 1.5% CaCl₂ | Fruit crisp with bite |
| Gala | 10% Glycerol + 1.5% CaCl₂ | Fruit crisp, v sweet/sour |
| | | good |
| Gala | 4.5% Sorbitol | Fruit soft, sweet, bite, |
| | | nice |
| Gala | 4.5% Sorbitol + 1.5% CaCl | Fruit crisp, sweet. |
| Gala | 4.5% Mannitol | Fruit, sweet/sour with |
| | | bite. |
| Gala | 4.5% Mannitol + 1.5% CaCl₂ | Fruit, crisp, sweet/sour |
| | | with bite |
| Gala | 4.5% Propylene Glycol | Fruit crisp with bite, |
| | | nice. |
| Gala | 7.5% Propylene Glycol + | Fruit crisp, sweet, nice |
| | 1.5% CaCl₂ | |
| Gala | 1.5% Glycerol + mannitol + | Fruit crisp, sweet/sour, |
| | sorbitol + Prop Gly | bite |
| Gala | 1.5% Glycerol + mannitol + | Fruit crisp, sweet/sour, |
| | sorbitol + Prop Gly + | bite |
| | 1.5% CaCl₂ | |
| Gala | 4% Glycerol + 1.5% CaNO₃ | Fruit crisp, sweet/sour |
| Gala | 4% Glycerol + 1.5% D- | Fruit crisp, sweet nice |
| | Glucose | |
| Gala | 4% Glycerol + 1.5% Ca | Fruit crisp, v sweet, |
| | gluconate | bite |
| Gala | 4% Glycerol + 1.5% KH₂PO₄ | Fruit crisp, refreshing |
| Gala | 4% Glycerol + 1.5% K₂HPO₄ | Fruit crisp, refreshing |
| Gala | 4% Glycerol + 1.5% | Fruit. Crisp, sweet/sour |
| | CaCitrate + 1.5% CaCl₂ | refreshing |
| Gala | 4% Glycerol + 1.5% KH₂PO₄ + | Fruit crisp, refreshing |
| | 1% CaCl₂ | |
| Gala | 4% Glycerol + 1.5% sucrose + | Fruit crisp, sweet/sour, |
| | 1% CaCl₂ | bite nice |
| Gala | 4% Sucaryl + 1% Sorbitol | Fruit and drink nice |
| Gala | 4% Sucaryl + 1% Glycerol | Fruit and drink excellent |
| Gala | 4% Equal + 1% Glycerol | Drink v.sour. Fruit |
| | | crisp, excellent |
| Gala | 2% Sugromax + 1% Glycerol | Drink v.sweet. Fruit |
| | | crisp, nice |
| Gala | 3% Sucaryl + 1% Glycerol + | Fruit and drink excellent |
| | 5% Grappa | |
| Pacific Rose | 4.5% PropyleneGly + 1.5% | Fruit crisp, nice |
| | CaCl₂ | |
| Pacific Rose | 5% PropyleneGly + 1.5% | Fruit crisp, nice |
| | CaCl₂ | |
| Pacific Rose | 4.5% Glycerol + 1.5% CaCl₂ | Fruit crisp, nice flavor |

### Example 17

Golden Queen Peaches

| | |
|---|---|
| 5.5% Glycerol. | Fruit good texture and taste |
| 5.5%. Glycerol + 0.5% CaCl₂ | ruit VG texture and taste |
| 5.5% Glycerol + 1.5% CaCl₂ | Fruit VG texture and taste |
| 6% Glycerol + 1% CaCl₂ | Fruit excellent |
| 5.5% Propylene Glycol | Fruit soft, sweet |
| 5.5% Mannitol | Fruit sweet, nice taste |
| 1.5% Glycerol + mannitol + sorbitol + | Fruit sweet, nice |
| prop. gly | |
| 4% Glycerol + 1% CaN0₃ | Fruit firm, sour |
| 4% Glycerol + 1% D-Glucose | Fruit VG texture and taste |
| 4% Glycerol + 1% MgSO₄ | Fruit good texture and taste |
| 4% Glycerol + 1% Sorbitol | Fruit firm, sweet, nice |

Plums

| | |
|---|---|
| 10% Glycerol + 4% Sucaryl | Fruit and drink nice |
| 8% Sucaryl + 2% Glycerol + 1% Sorbitol | Fruit and drink nice |
| 4% Sucaryl + 1% Glycerol | Nice drink and fruit, |
| | skin split |
| 3% Sucaryl + 3% Glycerol + 3% Sorbitol | Fruit and drink nice |
| 3% Sucaryl + 3% Glycerol + 3% Sorbitol + | Fruit and drink nice |
| 7.5% Brandy | |
| 3% Sucaryl + 3% Glycerol + 3% Sorbitol + | Fruit and drink nice |
| 7.5% Rum | |
| 8% Sucaryl + 2% Glycerol + 1% Sorbitol + | Fruit and drink nice |
| 7.5% Brandy | |
| 8% Sucaryl + 2% Glycerol + 1% Sorbitol + | Fruit and drink nice |
| 7.5% Rum | |
| 5% Glycerol + 5% Prop gly + 1.5% CaCl₂ + | Fruit firm good taste and |
| 1% K₂HPO₄ + 1% D-Glucose + 0.5% | texture |
| Ascorbic/Citric | |

Cherries

| | |
|---|---|
| 12.5% Glycerol + 1.5% CaCl₂ | Fruit good texture and taste |
| 15% Glycerol + 1% CaCl₂ | Fruit good texture and taste |
| 8% Sucaryl + 2% Glycerol + 2% Sorbitol | Fruit and drink nice |
| 8% Sucaryl + 4% Glycerol + 2% Sorbitol | Fruit and drink nice |

### Example 18

Strawberries

| | |
|---|---|
| 6% Sucaryl + 2% Glycerol | Fruit and drink very nice |
| 7.5% Sucaryl + 1.5% Glycerol + 1.5% | Fruit and drink nice |
| Sorbitol | |
| 4% Glycerol + 3% Sucaryl + 3% Prop. gly + | Fruit nice |
| 0.5% NaCl/CaCl₂ | |
| 4% Glycerol + 3% Prop. gly + 3% Sucaryl + | Fruit firm nice flavor |
| 1% Corn Syrup + 1% CaCl₂ + 0.5% NaCl | |

### Example 19

Chestnuts

| | |
|---|---|
| 5% Glycerol + 4% Sucaryl + 4% prop. gly | Drink like ginger ale, fruit |
| | good, nutty |
| 5% Glycerol + 4% Sucaryl + 4% prop. gly + | Drink like ginger ale, fruit |
| 7.5% Brandy | good, nutty |
| 5% Glycerol + 4% Sucaryl + 4% prop. gly + | Drink nice. Fruit good, |
| 7.5% Vodka | nutty |
| 5% Glycerol + 4% Sucaryl + 4% prop. gly + | Drink nice. Fruit good, |
| 7.5% Grappa | nutty |
| 10% Glycerol + 2% Sucaryl + 1.5% CaCl₂ | Fruit good |

### Example 20

Corn (Stored as cobbs in solution)

| | |
|---|---|
| 7.5 to 10% Sucaryl + 0.5% NaCl | Cobbs fresh |
| 5 to 7.5% Glycerol | Cobbs fresh |
| 5 to 7.5% Glycerol + 0.5% NaCl | Cobbs fresh |
| 7.5 to 10% Propylene Glycol | Cobbs fresh |
| 2.5 to 5.0% Propylene glycol + 0.5% | Cobbs fresh |
| NaCl | |

### Example 21

Golden delicious apples, lemons, Gold kiwifruit and Ginger pieces were immersed in various solutions for 15 days then weighed to see if water was taken up or lost.

Golden Delicious apples

| | Wgt (g) | Wgt (g) | Difference | Brix | |
|---|---|---|---|---|---|
| Treatment | start | finish | (g) | soln | Brix Fruit |
| Water | 194.87 | 195.86 | +0.99 | 0 | 8.6 |
| 2% Glycerol | 200.12 | 201.44 | +1.32 | 1.4 | 11 |
| 4% Glycerol | 195.25 | 195.45 | +0.20 | 3 | 8 |
| 4% Glycerol + CO₂ | 179.88 | 180.97 | +1.09 | 3.4 | 11 |
| 8% Glycerol | 189.03 | 189.09 | +0.06 | 6.8 | 9 |
| 2% Sucaryl + 1% | 199.86 | 199.86 | 0.0 | 1 | 9.8 |
| Glycerol | | | | | |
| 4% Sucaryl + 1% | 199.55 | 199.74 | +0.19 | 2 | 9 |
| Glycerol | | | | | |
| 4% Sucaryl + 1% | 186.2 | 186.20 | 00 | 1 | 11.2 |
| Glycerol + CO₂ | | | | | |
| 8% Sucaryl + | 195.47 | 197.44 | 2.47 | 2 | 7.6 |
| 2% Glycerol | | | | | |
| Mean | | | 0.70 | 2.28 | 9.46 |

Apart from two storage solutions (2% SUCARYL™+1% Glycerol, 4% SUCARYL™+1% Glycerol+CO₂) which appeared to be isotonic all other treatments appeared to be hypotonic, that is the fruit gained weight. The differential between the brix of the solution and the brix of the fruit was maintained. The presence of CO₂ did not affect membrane permeability. All solutions with SUCARYL™ elicited flavour from the fruit into the solution. Glycerol solutions did not elicit flavours and the solution tasted bland.

Lemon

| | Wgt (g) | Wgt (g) | Difference | Brix | |
|---|---|---|---|---|---|
| Treatment | start | finish | (g) | soln | Brix Fruit |
| Water | 179.04 | 183.71 | +4.67 | 0 | 6.8 - Soft |
| 2% Glycerol | 179.24 | 181.09 | +1.85 | 1.6 | 7.2 - Firm |
| 4% Glycerol | 177.96 | 178.97 | +1.01 | 3.4 | 7 - Firm |
| 4% Glycerol + CO2 | 175.02 | 175.58 | +0.56 | 3.4 | 6 - Soft |
| 8% Glycerol | 182.85 | 185.61 | +2.76 | 5 | 7.6 - Firm |
| 2% Sucaryl + | 189.20 | 190.92 | +1.72 | 0.6 | 7.2 - Firm |
| 1% Glycerol | | | | | |
| 4% Sucaryl + 1% | 194.76 | 198.18 | +3.42 | 1.4 | 6.4 - Soft |
| Glycerol | | | | | |
| 4% Sucaryl + 1% | 176.12 | 178.37 | +2.25 | 1.0 | 7.6 - Soft |
| Glycerol + CO2 | | | | | |
| 8% Sucaryl + | 177.93 | 182.44 | +4.51 | 3.0 | 7.4 - Firm |
| 2% Glycerol | | | | | |
| Mean | | | +2.53 | 2.15 | 7.02 |

All storage solutions appeared to be hypotonic and weight gains of fruit were more than apples. The brix differential of solutions and fruit were also maintained. Water, 4% SUCARYL™ and CO₂ softened fruit. The presence of SUCARYL™, elicited citrus flavour and made the drink palatable. This effect was enhanced by CO₂.

Gold Kiwifruit

| | Wgt (g) | Wgt (g) | Difference | Brix | |
|---|---|---|---|---|---|
| Treatment | start | finish | (g) | soln | Brix Fruit |
| Water | 201.58 | 202.88 | +1.30 | 0.0 | 11.6 |
| 2% Glycerol | 201.28 | 202.94 | +166 | 2.6 | 11.6 |
| 4% Glycerol | 205.47 | 205.98 | +0.51 | 4.0 | 12.2 |
| 4% Glycerol + CO2 | 197.90 | 198.44 | +0.54 | 5.0 | 9.6 |
| 8% Glycerol | 205.12 | 205.25 | +0.13 | 7.0 | 12.6 |
| 2% Sucaryl + | 194.11 | 195.71 | +0.60 | 0.8 | 11.4 |
| 1% Glycerol | | | | | |
| 4% Sucaryl + 1% | 205.12 | 206.60 | +1.48 | 1.4 | 13.8 |
| Glycerol | | | | | |
| 4% Sucaryl + 1% | 210.03 | 211.94 | +1.91 | 1.0 | 14.0 |
| Glycerol + CO2 | | | | | |
| 8% Sucaryl + | 198.06 | 198.72 | +0.66 | 3.0 | 10.6 |
| 2% Glycerol | | | +0.97 | 2.75 | 11.93 |

All storage solutions appeared to be hypotonic and weight gains of fruit were similar to apples. The brix differential of solutions and fruit were also maintained. Water, 4% SUCARYL™ and CO₂ softened fruit. The presence of SUCARYL™ elicited flavour and made the drink palatable. This effect was enhanced by CO₂.

Ginger pieces

| | Wgt (g) | Wgt (g) | Difference | Brix | |
|---|---|---|---|---|---|
| Treatment | start | finish | (g) | soln | Brix Fruit |
| Water | 11.76 | 13.37 | +1.61 | 0.0 | 3.0 |
| 2% Glycerol | 27.42 | 29.76 | +2.34 | 1.8 | 3.0 |
| 4% Glycerol | 20.1 | 22.64 | +2.63 | 3.0 | 4.4 |
| 4% Glycerol + CO2 | 33.97 | 34.24 | +0.27 | 3.0 | 3.6 |
| 8% Glycerol | 26.20 | 28.54 | +2.34 | 5.0 | 5.2 |
| 2% Sucaryl + | 28.85 | 32.41 | +3.56 | 0.8 | 2.6 |
| 1% Glycerol | | | | | |
| 4% Sucaryl + 1% | 23.86 | 26.80 | +2.94 | 1.0 | 3.4 |
| Glycerol | | | | | |
| 4% Sucaryl + 1% | 35.50 | 37.32 | +1.82 | 1.2 | 1.4. |
| Glycerol + CO2 | | | | | |
| 8% Sucaryl + 2% | 27.63 | 29.77 | +2.14 | 2.4 | 4.0 |
| Glycerol | | | | | |
| Mean | 26.14 | 28.31 | 2.18 | 2.o2 | 3.4 |

All storage solutions appeared to be hypotonic and weight gains of fruit were more than apples. The brix differential of solutions and fruit were also maintained. Water, 4% SUCARYL™ and CO₂ softened fruit. The presence of SUCARYL™, elicited citrus flavour and made the drink palatable. This effect was enhanced by CO₂.

The mean data from the foregoing is summarised in the following Table:

| Fruit | Mean weight gain | Brix soln | Brix Fruit |
|---|---|---|---|
| Apple | 0.70 | 2.28 | 9.46 |
| Lemon | 2.53 | 2.15 | 7.02 |
| Kiwi | 0.97 | 2.75 | 11.93 |
| Ginger | 2.18 | 2.02 | 3.4 |

All storage solutions appeared to be hypotonic but the increase in wet weight was peculiar to the type of produce. This may be explained by consideration of the structure of the whole or diced produce. For instance apple and kiwifruit are both bound by thin skins and both gained a similar amount of weight. Citrus has a thick skin which possibly absorbed solution. The sliced ginger had no external membrane and gained weight. All types of produce maintained the brix difference between the external solution and the inside of the produce, even ginger, indicating cellular integrity is maintained. Carbonation did not appear to rupture cell membranes. Artificial sweeteners elicited fruit flavours into the solute.

Although the invention has been described by way of a first, second and third embodiment of the package beverage and numerous examples of possible storage solutions for use in the method, it is to be appreciated that improvements and/or modifications may be made to these embodiments and examples without departing from the scope of the invention as described. Where in the foregoing description reference has been made to integers or components having known equivalents, then such equivalents are incorporated as if individually set forth.

1-24. (canceled)

25. A packaged beverage comprising a releasably sealed container containing harvested produce immersed in an aqueous storage solution where the container comprises a first releasable seal and a second releasable seal configured to permit the egress of the storage solution without the harvested produce when the first releasable seal is released and egress of the harvested produce when the second releasable seal is released.

26. The packaged beverage of claim 25 where a neutral water potential is established when the harvested produce is immersed in the aqueous storage solution.

27. The packaged beverage of claim 25 where the storage solution is a moderately hypotonic to substantially isotonic storage solution.

28. The packaged beverage of claim 25 where there is no significant change in the Brix value of the storage solution of the packaged beverage during the period of storage.

29. The packaged beverage of claim 25 where the storage solution is a carbonated storage solution.

30. The packaged beverage of claim 25 where the storage solution is an alcoholic storage solution.

31. The packaged beverage of claim 30 where the storage solution is an alcoholic storage solution where the source of alcohol is selected from the group consisting of: pomace brandy, triple sec liqueur, gin, vodka, whisky, whiskey and bourbon.

32. The packaged beverage of claim 25 where the storage solution comprises a combination of solutes selected from the group consisting of: artificial sweeteners and polyhydric alcohols (polyols).

33. The packaged beverage of claim 32 where the storage solution comprises a combination of artificial sweeteners and polyhydric alcohols (polyols) where the artificial sweeteners are selected from the group consisting of: SUCARYL™ (Abbott) (sodium cyclamate 8% (w/v) (952), sodium saccharin 0.8% (w/v) (954), benzoic acid 0.1% (210)); EQUAL™ (Merisant) (5% Benzoic acid (210), potassium benzoate (212)) and SUGORMAX™ (Hansells) (16% sodium cyclamate, 4% saccharin, malic acid, preservatives (211, 202)) and the polyhydric alcohols (polyols) are selected from the group consisting of: glycerol, inositol, mannitol, and sorbitol.

34. The packaged beverage of claim 25 where the harvested produce is whole fruit.

35. The packaged beverage of claim 34 where the harvested produce is whole fruit selected from the group consisting of: apple, blackberries, blueberries, cherries, citrus, grapes, kiwifruit, peaches, pear, plums, raspberries and strawberries.

36. The packaged beverage of claim 25 where the harvested produce is diced root vegetables.

37. The packaged beverage of claim 36 where the harvested produce is diced root vegetables selected from the group consisting of: beetroot, carrot and ginger.

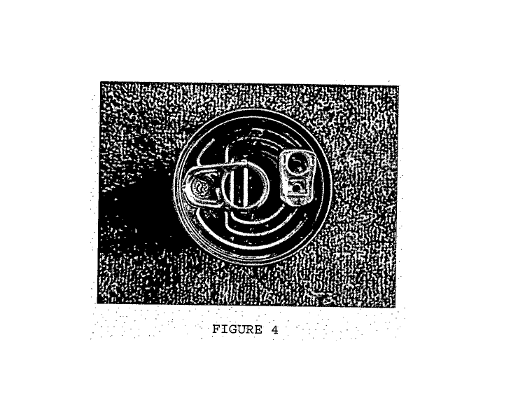

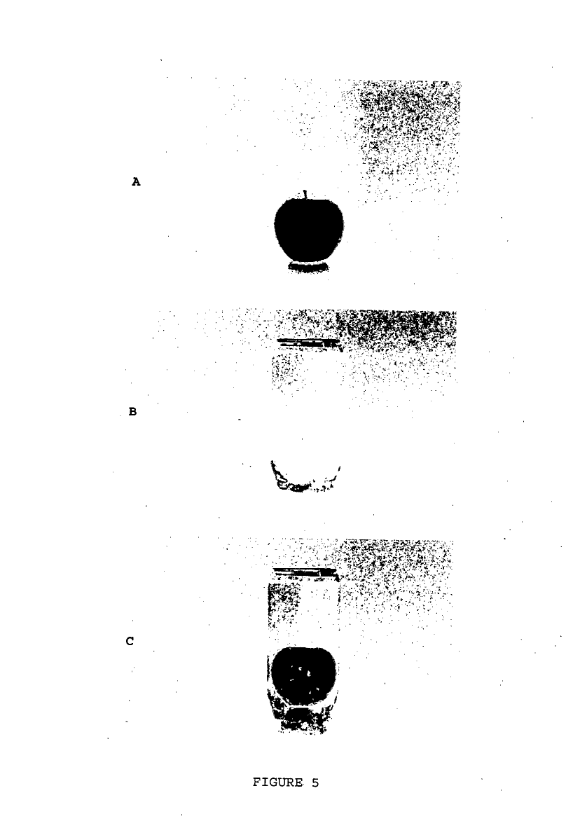

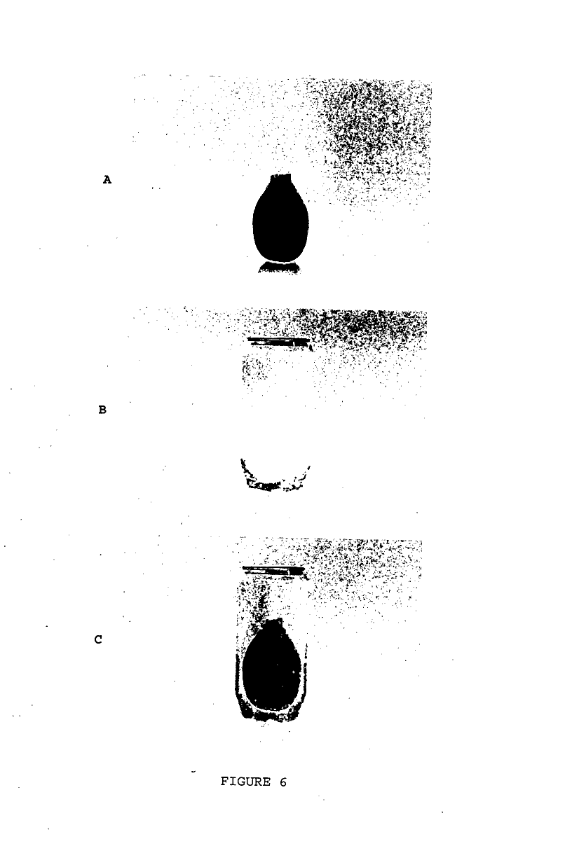

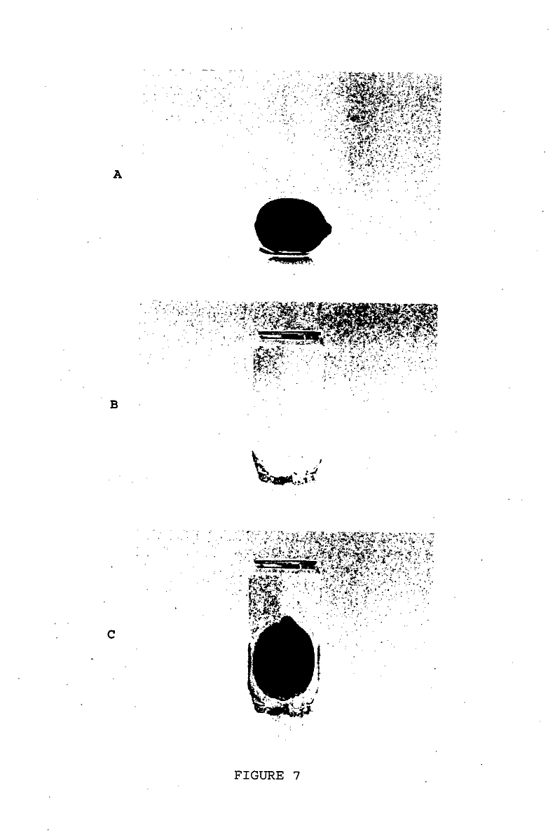

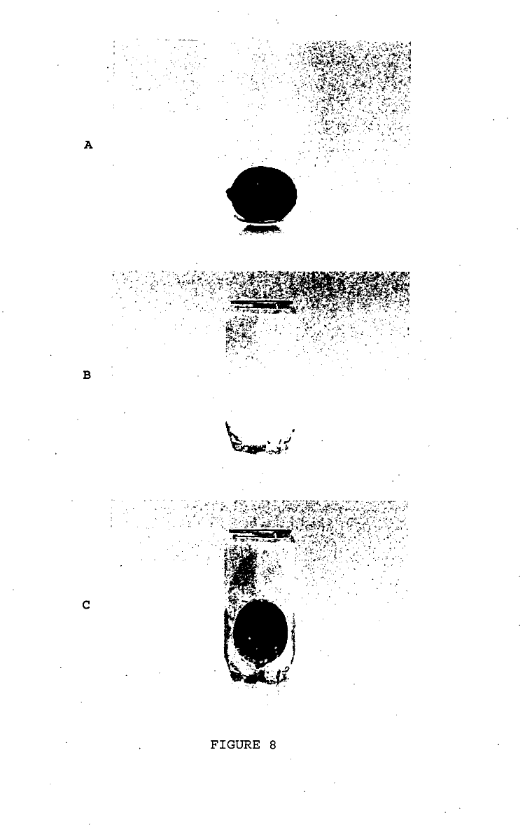

38. The packaged beverage of claim 25 substantially as described in the specification and illustrated in FIGS. 1 to 8 of the drawings pages.

39. The packaged beverage of claim 25 substantially as described in the specification and illustrated in FIGS. 9 to 11 of the drawings pages.

40. The packaged beverage of claim 25 substantially as described in the specification and illustrated in FIGS. 12 to 14 of the drawings pages.

41. The packaged beverage of claim 25 containing a combination of produce and storage solution as described in the Examples.
